(19) United States
(12) Patent Application Publication
(10) Pub. No.: US 2020/0274592 A1
(43) Pub. Date: Aug. 27, 2020

(54) NULL-SPACE-PROJECTION-BASED CHANNEL DECOMPOSTION FOR BEAMFORMING

(71) Applicant: QUALCOMM Incorporated, San Diego, CA (US)

(72) Inventors: Yashwanth MANDULA, Bangalore (IN); Gopala Krishna Murthy VEMULA, Krishna District (IN); Suresh CHANDRASEKARAN, Chennai (IN); Ashutosh Deepak GORE, Bangalore (IN); Swaroop VENKATESH, San Ramon, CA (US); Louay JALLOUL, San Jose, CA (US); Ahmad Abdulrahman MOHAMMED, San Jose, CA (US); Yen-Feng LEE, San Jose, CA (US); Pedram PAYSARVI HOSEINI, San Jose, CA (US); Chi-Lin SU, Zhubei City (TW); Youhan KIM, Saratoga, CA (US)

(21) Appl. No.: 16/782,709

(22) Filed: Feb. 5, 2020

(30) Foreign Application Priority Data
Feb. 27, 2019 (IN) 201941007678

(51) Int. Cl. H04B 7/06; H04B 7/0417; H04B 7/0456; H04L 25/02; H04W 80/04; H04L 25/03

(52) U.S. Cl. CPC H04B 7/0617; H04B 7/0417; H04L 25/0391; H04L 25/0224; H04W 80/04; H04B 7/0456

(57) ABSTRACT

This disclosure provides methods, devices and systems for obtaining and providing channel feedback. In some implementations, a beamformee provides channel feedback to a beamformer that enables the beamformer to construct and independently precode two or more different sets of spatial streams for transmission to the beamformee. The independent precoding of the different sets of spatial streams ensures that the decodings of the different sets of spatial streams may be decoupled from one another at the beamformee. To provide the channel feedback, the beamformee partitions a channel estimate into two or more sub-estimates prior to performing a channel decomposition. In some implementations, the beamformee determines null-space-based projections of the sub-estimates before performing the channel decomposition. The determination of the null-space-based projections enables the beamformee to perform independent decompositions of the multiple channel sub-estimates to determine multiple respective feedback matrices, which are then assembled to provide the channel feedback to the beamformer. The channel feedback is then reconstructed and disassembled by the beamformer to perform the independent precoding of the different sets of spatial streams.

### PRIORITY INFORMATION

This patent application claims priority under 35 U.S.C. 119(a) to Indian provisional patent application serial no. 201941007678 entitled “Null-Space-Projection-Based Channel Decomposition for Beamforming” and filed on 27 Feb. 2019, the content of which is hereby incorporated by reference herein for all purposes.

### TECHNICAL FIELD

This disclosure relates generally to beamforming techniques for wireless communication, and more particularly, to techniques for obtaining and providing channel feedback.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

APs and STAs that include multiple antennas may support beamforming. Beamforming refers to the focusing of the energy of a transmission in the direction of a target receiver. Beamforming may be used both in a single-user context, for example, to improve a signal-to-noise ratio (SNR), as well as in a multi-user (MU) context, for example, to enable MU multiple-input multiple-output (MIMO) (MU-MIMO) transmissions. To perform beamforming, a transmitting device, referred to as the beamformer, transmits a signal from each of multiple antennas. The beamformer configures the amplitudes and phase shifts between the signals transmitted from the different antennas such that the signals add constructively along particular directions towards the intended receivers, which are referred to as beamformees. The manner in which the beamformer configures the amplitudes and phase shifts depends on channel state information (CSI) associated with the wireless channels over which the beamformer intends to communicate with the beamformee.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication by a first wireless communication device. The method includes receiving, from a second wireless communication device, a sounding signal, and generating a channel estimate matrix H based on the sounding signal. The method also includes partitioning the channel estimate matrix H into a first channel estimate matrix H₁ and a second channel estimate matrix H₂, determining a first projection matrix P₁ based on the second channel estimate matrix H₂, and determining a second projection matrix P₂ based on the first channel estimate matrix H₁. The method additionally includes determining a first effective channel estimate matrix H_{Eff1} based on the first channel estimate matrix H₁ and the first projection matrix P₁, and determining a second effective channel estimate matrix H_{Eff2} based on the second channel estimate matrix H₂ and the second projection matrix P₂. The method further includes determining a combined feedback matrix Z based on the first effective channel estimate matrix H_{Eff1} and the second effective channel estimate matrix H_{Eff2}, and outputting channel feedback information based on the combined feedback matrix Z for transmission to the second wireless communication device.

Another innovative aspect of the subject matter described in this disclosure can be implemented in a first wireless communication device. The first wireless communication device includes at least one processor and at least one memory communicatively coupled with the at least one processor and storing processor-readable code that, when executed by the at least one processor, causes the first wireless communication device to perform operations. The operations include receiving, from a second wireless communication device, a sounding signal, and generating a channel estimate matrix H based on the sounding signal. The operations also include partitioning the channel estimate matrix H into a first channel estimate matrix H₁ and a second channel estimate matrix H₂, determining a first projection matrix P₁ based on the second channel estimate matrix H₂, and determining a second projection matrix P₂ based on the first channel estimate matrix H₁. The operations additionally include determining a first effective channel estimate matrix H_{Eff1} based on the first channel estimate matrix H₁ and the first projection matrix P₁, and determining a second effective channel estimate matrix H_{Eff2} based on the second channel estimate matrix H₂ and the second projection matrix P₂. The operations further include determining a combined feedback matrix Z based on the first effective channel estimate matrix H_{Eff1} and the second effective channel estimate matrix H_{Eff2}, and outputting channel feedback information based on the combined feedback matrix Z for transmission to the second wireless communication device.

In some implementations of the method and the first wireless communication device above, the determination of the first projection matrix P₁ comprises determining the first projection matrix P₁ from the null space of the second channel estimate matrix H₂, and the determination of the second projection matrix P₂ comprises determining the second projection matrix P₂ from the null space of the first channel estimate matrix H₁.

In some implementations, the determination of the combined feedback matrix Z based on the first effective channel estimate matrix H_{Eff1} and the second effective channel estimate matrix H_{Eff2} comprises determining a first intermediate matrix V₁ based on the first effective channel estimate matrix H_{Eff1}, and determining a second intermediate matrix V₂ based on the second effective channel estimate matrix H_{Eff2}. The determination of the combined feedback matrix Z is based on the first intermediate matrix V₁ and the second intermediate matrix V₂. In some implementations, the determination of the first intermediate matrix V₁ based on the first effective channel estimate matrix H_{Eff1} comprises performing a first factorization operation on the first effective channel estimate matrix H_{Eff1}, and the determination of the second intermediate matrix V₂ based on the second effective channel estimate matrix H_{Eff2} comprises performing a second factorization operation on the second effective channel estimate matrix H_{Eff2}. In some such implementations, the performance of the first factorization operation on the first effective channel estimate matrix H_{Eff1} comprises performing a first singular value decomposition (SVD) operation on the first effective channel estimate matrix H_{Eff1}, and the performance of the second factorization operation on the second effective channel estimate matrix H_{Eff2} comprises performing a second SVD operation on the second effective channel estimate matrix H_{Eff2}. In some implementations, the determination of the combined feedback matrix Z comprises determining a first feedback matrix Z₁ based on the first intermediate matrix V₁ and the first projection matrix P₁, determining a second feedback matrix Z₂ based on the second intermediate matrix V₂ and the second projection matrix P₂, and determining the combined feedback matrix Z based on the first feedback matrix Z₁ and the second feedback matrix Z₂. In some implementations, the combined feedback matrix Z is an orthonormal block-diagonal matrix, and the determination of the orthonormal block-diagonal steering matrix Z comprises stacking the first feedback matrix Z₁ and the second feedback matrix Z₂ such that the first and the second precoding matrices do not share any rows or columns in the combined feedback matrix Z.

In some implementations, the first wireless communication device comprises or is coupled with N_{Rx} antennas configured to receive packets, the second wireless communication device comprises or is coupled with N_{Tx} antennas configured to transmit packets, the channel estimate matrix H comprises an N_{Rx}×N_{Tx} matrix, the first channel estimate matrix H₁ consists of N_{SS1} rows and N_{Tx} columns of the channel estimate matrix H, the second channel estimate matrix H₂ consists of N_{SS2} rows and N_{Tx} columns of the channel estimate matrix H, wherein the N_{SS1} rows are different than the N_{SS2} rows. In some such implementations, the channel feedback information includes at least one of an indication of N_{SS1} or an indication of N_{SS2}.

In some implementations, the method and operations also include receiving at least one beamformed transmission based on the channel feedback information, where the at least one beamformed transmission comprises at least one packet received via a number N_{SS} of spatial streams. In some such implementations, the method and operations additionally include partitioning the spatial streams into a first set of N_{SS1} spatial streams and a second set of N_{SS2} spatial streams, wherein N_{SS1}+N_{SS2}=N_{SS}. In some such implementations, the method and operations further include generating a channel estimate matrix H_{B} based on the beamformed transmission, partitioning the channel estimate matrix into a first channel estimate matrix H_{B1} and a second channel estimate matrix H_{B2}, decoding the first set of N_{SS1} spatial streams based on the first channel estimate matrix H_{B1} and the first feedback matrix Z₁, and decoding the second set of N_{SS2}, spatial streams based on the second channel estimate matrix H_{B2} and the second feedback matrix Z₂. In some such implementations, the decoding of the first set of N_{SS1} spatial streams based on the first channel estimate matrix H_{B1} and the first feedback matrix Z₁ comprises performing a first maximum likelihood (ML) equalization operation on the first set of N_{SS1} spatial streams based on the first channel estimate matrix H_{B1} and the first feedback matrix Z₁ to generate a first sequence of complex numbers, determining a first set of logarithm likelihood ratio (LLR) values based on the first sequence of complex numbers on a per bit position, per subcarrier, per spatial stream basis, and decoding information bits for the first set of N_{SS1} spatial streams based on the first set of LLR values. Similarly, the decoding of the second set of N_{SS2} spatial streams based on the second channel estimate matrix H_{B2} and the second feedback matrix Z₂ comprises performing a second ML equalization operation on the second set of N_{SS2} spatial streams based on the second channel estimate matrix H_{B2} and the second feedback matrix Z₂ to generate a second sequence of complex numbers, determining a second set of LLR values based on the second sequence of complex numbers on a per bit position, per subcarrier, per spatial stream basis, and decoding information bits for the second set of N_{SS2}, spatial streams based on the second set of LLR values.

Another innovative aspect of the subject matter described in this disclosure can be implemented in method for wireless communication by a first wireless communication device. The method includes outputting, for transmission to a second wireless communication device, a sounding signal. The method also includes receiving channel feedback information from the second wireless device based on the sounding signal, and determining a first precoding matrix Z₁ and a second precoding matrix Z₂ based on the channel feedback information. The method additionally includes generating at least one physical layer convergence protocol (PLCP) protocol data unit (PPDU) including data for the second wireless communication device, and partitioning the at least one PPDU into a first set of N_{SS1} spatial streams and a second set of N_{SS2}, spatial streams. The method further includes applying the first precoding matrix Z₁ to the first set of N_{SS1} spatial streams to generate a first set of precoded streams, and applying the second precoding matrix Z₂ to the second set of N_{SS2} spatial streams to generate a second set of precoded streams. The method further includes outputting the first and the second sets of precoded streams for transmission to the second wireless communication device.

Another innovative aspect of the subject matter described in this disclosure can be implemented in a first wireless communication device. The first wireless communication device includes at least one processor and at least one memory communicatively coupled with the at least one processor and storing processor-readable code that, when executed by the at least one processor, causes the first wireless communication device to perform operations. The operations include outputting, for transmission to a second wireless communication device, a sounding signal. The operations also include receiving channel feedback information from the second wireless device based on the sounding signal, and determining a first precoding matrix Z₁ and a second precoding matrix Z₂ based on the channel feedback information. The operations additionally include generating at least one physical layer convergence protocol (PLCP) protocol data unit (PPDU) including data for the second wireless communication device, and partitioning the at least one PPDU into a first set of N_{SS1} spatial streams and a second set of N_{SS2} spatial streams. The operations further include applying the first precoding matrix Z₁ to the first set of N_{SS1} spatial streams to generate a first set of precoded streams, and applying the second precoding matrix Z₂ to the second set of N_{SS2} spatial streams to generate a second set of precoded streams. The operations further include outputting the first and the second sets of precoded streams for transmission to the second wireless communication device.

In some implementations of the method and the first wireless communication device above, the determinations of the first precoding matrix Z₁ and the second precoding matrix Z₂ comprise generating a steering matrix Z based on the channel feedback information, where the determinations of the first precoding matrix Z₁ and the second precoding matrix Z₂ are based on the elements of the steering matrix. In some implementations of the method and the first wireless communication device, the channel feedback information includes at least one of an indication of N_{SS1} or an indication of N_{SS2}.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2A shows an example physical layer (PHY) preamble usable for communications between an access point (AP) and a number of stations (STAs).

FIG. 2B shows another example PHY preamble usable for communications between an AP and a number of STAs.

FIG. 3 shows a block diagram of an example wireless communication device.

FIG. 4A shows a block diagram of an example access point (AP).

FIG. 4B shows a block diagram of an example station (STA).

FIG. 5 shows a flowchart illustrating an example process for a first wireless communication device to provide channel feedback information to a second wireless communication device according to some implementations.

FIG. 6 shows a flowchart illustrating an example process for determining a combined feedback matrix according to some implementations.

FIG. 7 shows a flowchart illustrating an example process for a first wireless communication device to decode a beamformed transmission received from a second wireless communication device according to some implementations.

FIG. 8 shows a flowchart illustrating an example process for decoding sets of spatial streams according to some implementations.

FIG. 9 shows a flowchart illustrating an example process for a first wireless communication device to generate a beamformed transmission for a second wireless communication device according to some implementations.

FIG. 10 shows a block diagram of an example wireless communication device for use in wireless communication according to some implementations.

FIG. 11 shows a block diagram of an example wireless communication device for use in wireless communication according to some implementations.

FIG. 12 shows a block diagram of an example wireless communication device for use in wireless communication according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to beamforming techniques for wireless communication, and more particularly, to techniques for obtaining and providing channel feedback. In some implementations, a beamformee provides channel feedback to a beamformer that enables the beamformer to construct and independently precode two or more different sets of spatial streams for transmission to the beamformee. The independent precoding of the different sets of spatial streams ensures that the decodings of the different sets of spatial streams may be decoupled from one another at the beamformee. To provide the channel feedback, the beamformee partitions a channel estimate into two or more sub-estimates prior to performing a channel decomposition. In some implementations, the beamformee determines null-space-based projections of the sub-estimates before performing the channel decomposition. The determination of the null-space-based projections enables the beamformee to perform independent decompositions of the multiple channel sub-estimates to determine multiple respective feedback matrices, which are then assembled to provide the channel feedback to the beamformer. The channel feedback is then reconstructed and disassembled by the beamformer to perform the independent precoding of the different sets of spatial streams.

Particular implementations of the subject matter described in this disclosure can be implemented to realize one or more of the following potential advantages. In some implementations, the described techniques can be used to increase the throughput for a given range, or to enable a greater range for a given throughput, by increasing the number N_{SS} of spatial streams that may be used for beamforming.

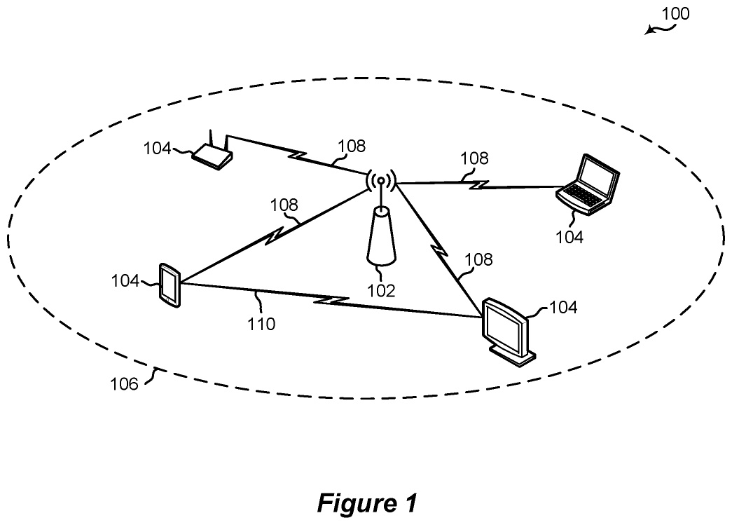

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 100 may include numerous wireless communication devices such as an access point (AP) 102 and multiple stations (STAs) 104. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a media access control (MAC) address of the AP 102. The AP 102 periodically broadcasts beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 108) according to the IEEE 802.11 family of standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a PLCP service data unit (PSDU). The information provided in the preamble may be used by a receiving device to decode the subsequent data in the PSDU. A legacy portion of the preamble may include a legacy short training field (STF) (L-STF), a legacy long training field (LTF) (L-LTF), and a legacy signaling field (L-SIG). The legacy preamble may be used for packet detection, automatic gain control and channel estimation, among other uses. The legacy preamble also may be used to maintain compatibility with legacy devices. In instances in which PPDUs are transmitted over a bonded channel, the L-STF, L-LTF, and L-SIG fields may be duplicated and transmitted in each of the multiple component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

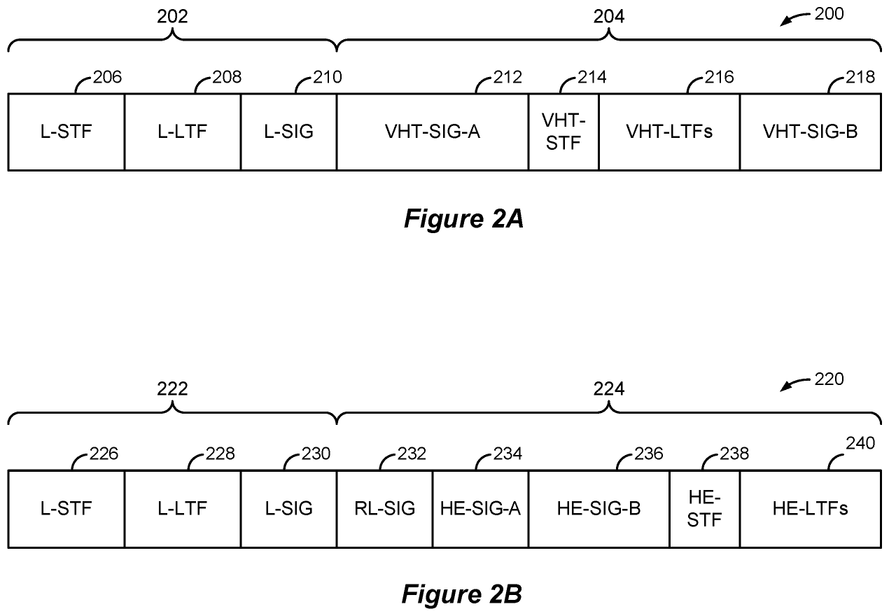

FIG. 2A shows an example PHY preamble 200 usable for communications between an AP 102 and each of a number of STAs 104. The preamble 200 includes a legacy portion 202 and a non-legacy portion 204. The legacy portion 202 includes L-STF 206, L-LTF 208, and L-SIG 210. The non-legacy preamble portion 204 is formatted as a very high throughput (VHT) preamble in accordance with the IEEE 802.11ac amendment to the IEEE 802.11 standard. The non-legacy preamble portion 204 includes a first VHT signaling field (VHT-SIG-A) 212, a VHT short training field (VHT-STF) 214, one or more VHT long training fields (VHT-LTFs) 216 and a second VHT signaling field (VHT-SIG-B) 218 encoded separately from the VHT-SIG-A field 212. Like the L-STF 206, L-LTF 208, and L-SIG 210, the information in the VHT-SIG-A field 212 may be duplicated and transmitted in each of the component 20 MHz channels in instances involving the use of a bonded channel.

The VHT-STF 214 is used to improve automatic gain control estimation in a MIMO transmission. The VHT-LTFs 216 are used for MIMO channel estimation and pilot subcarrier tracking. The preamble 200 includes one VHT-LTF 216 for each spatial stream indicated by the selected MCS. The VHT-SIG-A field 212 may indicate to 802.11ac-compatible APs 102 and STAs 104 that the PPDU is a VHT PPDU. The VHT-SIG-A field 212 includes signaling information and other information usable by STAs 104 to decode the VHT-SIG-B field 218. The VHT-SIG-A field 212 may indicate a bandwidth (BW) of the packet, the presence of space-time block coding (STBC), the number N_{STS} of space-time streams per user, a Group ID indicating the group and user position assigned to a STA, a partial association identifier that may combine the AID and the BSSID, a short guard interval (GI) indication, a single-user/multi-user (SU/MU) coding indicating whether convolutional or LDPC coding is used, a modulation and coding scheme (MCS), an indication of whether a beamforming matrix has been applied to the transmission, a cyclic redundancy check (CRC) and a tail. The VHT-SIG-B field 218 is used for MU transmissions and contains the actual data rate and A-MPDU length value for each of the multiple STAs 104, as well as signaling information usable by the STAs 104 to decode data received in the payload portion of the PPDU, including, for example, an MCS and beamforming information.

FIG. 2B shows another example PHY preamble 220 usable for communications between an AP 102 and each of a number of stations 104. The preamble 220 may be used for MU-OFDMA or MU-MIMO transmissions. The preamble 220 includes a legacy portion 222 and a non-legacy portion 224. The legacy portion 222 includes L-STF 226, L-LTF 228, and L-SIG 230. The non-legacy preamble portion 204 is formatted as a high efficiency (HE) frame in accordance with the IEEE 802.11ax amendment to the IEEE 802.11 standard. The non-legacy preamble portion 224 includes a repeated legacy signaling field (RL-SIG) 232, a first HE signaling field (HE-SIG-A) 234, a second HE signaling field (HE-SIG-B) 236 encoded separately from the HE-SIG-A field 234, an HE short training field (HE-STF) 238 and HE long training fields (HE-LTFs) 240. Like the L-STF 226, L-LTF 228, and L-SIG 230, the information in the RL-SIG field 232 and the HE-SIG-A field 234 may be duplicated and transmitted in each of the component 20 MHz channels in instances involving the use of a bonded channel.

The RL-SIG field 232 may indicate to an HE-compatible STA 104 that the PPDU is an HE PPDU. An AP 102 may use the HE-SIG-A field 234 to indicate to multiple identified STAs 104 that the AP has scheduled UL or DL resources. The HE-SIG-A field 234 may be decoded by each HE-compatible STA 104 served by the AP 102. The HE-SIG-A field 234 includes information usable by the identified STAs 104 to decode associated HE-SIG-B fields 236. For example, the HE-SIG-A field 234 may indicate the frame format, including locations and lengths of HE-SIG-B fields 236, available channel bandwidths, modulation and coding schemes (MCS), among other possibilities. The HE-SIG-A field 234 also may include HE WLAN signaling information usable by STAs 104 other than the number of identified STAs 104.

The HE-SIG-B fields 236 carry STA-specific scheduling information such as, for example, per-user MCS values and per-user RU allocation information. In the context of DL MU-OFDMA, such information enables the respective STAs 104 to identify and decode corresponding RUs in the associated data field. Each HE-SIG-B field 236 includes a common field and at least one STA-specific (“user-specific”) field. The common field can indicate RU distributions to multiple STAs 104, indicate the RU assignments in the frequency domain, indicate which RUs are allocated for MU-MIMO transmissions and which RUs correspond to MU-OFDMA transmissions, the number of users in allocations, among other possibilities. The common field may be encoded with common bits, cyclic redundancy check (CRC) bits, and tail bits. The user-specific fields are assigned to particular STAs 104 and used to schedule specific RUs and to indicate the scheduling to other WLAN devices. Each user-specific field may include multiple user block fields (which may be followed by padding). Each user block field may include two user fields that contain information for two STAs to decode their respective RU payloads.

APs and STAs that include multiple antennas may support various diversity schemes. For example, spatial diversity may be used by one or both of a transmitting device or a receiving device to increase the robustness of a transmission. For example, to implement a transmit diversity scheme, a transmitting device may transmit the same data redundantly over two or more antennas. APs and STAs that include multiple antennas may also support space-time block coding (STBC). With STBC, a transmitting device also transmits multiple copies of a data stream across a number of antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams (described below). The N_{SS} spatial streams may be mapped to a number N_{STS} of space-time streams, which are then mapped to N_{Tx} transmit chains.

APs and STAs that include multiple antennas may also support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are then separately encoded and transmitted in parallel via the multiple N_{Tx} transmit antennas. If the transmitting device includes N_{Tx} transmit antennas and the receiving device includes N_{Rx} receive antennas, the maximum number N_{SS} of spatial streams that the transmitting device can simultaneously transmit to the receiving device is limited by the lesser of N_{Tx} and N_{Rx}. In some implementations, the AP 102 and STAs 104 may be able to implement both transmit diversity as well as spatial multiplexing. For example, in instances in which the number N_{SS} of spatial streams is less than the number N_{Tx} of transmit antennas, the spatial streams may be multiplied by a spatial expansion matrix to achieve transmit diversity.

APs and STAs that include multiple antennas may also support beamforming. Beamforming refers to the focusing of the energy of a transmission in the direction of a target receiver. Beamforming may be used both in a single-user context, for example, to improve a signal-to-noise ratio (SNR), as well as in a multi-user (MU) context, for example, to enable MU multiple-input multiple-output (MIMO) (MU-MIMO) transmissions. To perform beamforming, a transmitting device, referred to as the beamformer, transmits a signal from each of multiple antennas. The beamformer configures the amplitudes and phase shifts between the signals transmitted from the different antennas such that the signals add constructively along particular directions towards the intended receivers, which are referred to as beamformees. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, a null data packet (NDP)) to the beamformee. The beamformee may then perform measurements for each of the N_{Tx}×N_{Rx} sub-channels corresponding to all of the transmit antenna and receive antenna pairs based on the sounding signal. The beamformee generates a feedback matrix based on the channel measurements and, typically, compresses the feedback matrix before transmitting the feedback to the beamformer. The beamformer may then generate a precoding (or “steering”) matrix for the beamformee based on the feedback and use the steering matrix to precode the data streams to configure the amplitudes and phase shifts for subsequent transmissions to the beamformee.

As described above, a transmitting device may support the use of diversity schemes. When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions by increasing the number of transmit antennas. This is especially advantageous in MU transmission contexts in which it is particularly important to reduce inter-user interference.

As described above, APs 102 and STAs 104 can support multi-user (MU) communications; that is, concurrent transmissions from one device to each of multiple devices (for example, multiple simultaneous downlink (DL) communications from an AP 102 to corresponding STAs 104), or concurrent transmissions from multiple devices to a single device (for example, multiple simultaneous uplink (UL) transmissions from corresponding STAs 104 to an AP 102). To support the MU transmissions, the APs 102 and STAs 104 may utilize multi-user multiple-input, multiple-output (MU-MIMO) and multi-user orthogonal frequency division multiple access (MU-OFDMA) techniques.

In MU-OFDMA schemes, the available frequency spectrum of the wireless channel may be divided into multiple resource units (RUs) each including a number of different frequency subcarriers (“tones”). Different RUs may be allocated or assigned by an AP 102 to different STAs 104 at particular times. The sizes and distributions of the RUs may be referred to as an RU allocation. In some implementations, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Larger 52 tone, 106 tone, 242 tone, 484 tone and 996 tone RUs may also be allocated. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL MU-OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

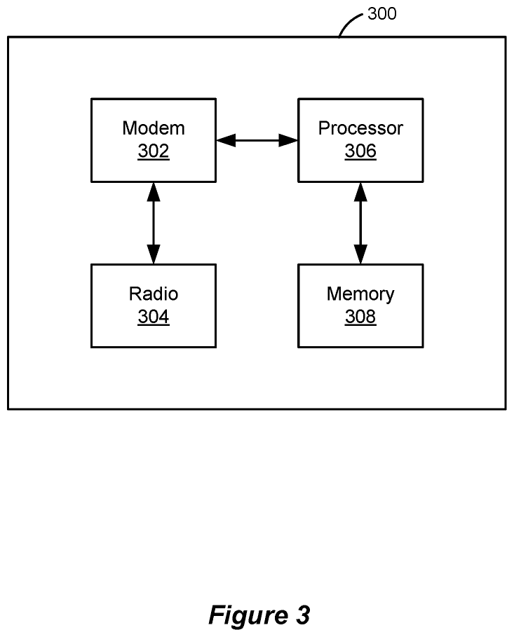

FIG. 3 shows a block diagram of an example wireless communication device 300. In some implementations, the wireless communication device 300 can be an example of a device for use in a STA such as one of the STAs 104 described above with reference to FIG. 1. In some implementations, the wireless communication device 300 can be an example of a device for use in an AP such as the AP 102 described above with reference to FIG. 1. The wireless communication device 300 is capable of outputting and receiving wireless communications (for example, in the form of wireless packets). For example, the wireless communication device can be configured to output and receive packets in the form of physical layer convergence protocol (PLCP) protocol data units (PPDUs) and Media Access Control (MAC) protocol data units (MPDUs) conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 300 can be or can include a chip, system on chip (SoC) or chipset that includes one or more modems 302, for example, a Wi-Fi (IEEE 802.11 compliant) modem. In some implementations, the one or more modems 302 (collectively “the modem 302”) additionally include a WWAN modem (for example, a 3GPP 4G LTE or 5G compliant modem). In some implementations, the wireless communication device 300 also includes one or more radios 304 (collectively “the radio 304”). In some implementations, the wireless communication device 306 further includes one or more processors, processing blocks or processing elements 306 (collectively “the processor 306”) and one or more memory blocks or elements 308 (collectively “the memory 308”).

The modem 302 can include an intelligent hardware block or device such as, for example, an application-specific integrated circuit (ASIC) among other possibilities. The modem 302 is generally configured to implement a PHY layer. For example, the modem 302 is configured to modulate packets and to provide the modulated packets to the radio 304 for transmission over the wireless medium. The modem 302 is similarly configured to obtain modulated packets received by the radio 304 and to demodulate the packets to provide demodulated packets. In addition to a modulator and a demodulator, the modem 302 may further include digital signal processing (DSP) circuitry, automatic gain control (AGC), a coder, a decoder, a multiplexer and a demultiplexer. For example, while in a transmission mode, data obtained from the processor 306 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 304. In implementations involving beamforming, the modulated symbols in the respective spatial streams are precoded via a steering matrix prior to their provision to the IFFT block.

While in a reception mode, digital signals received from the radio 304 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 306) for processing, evaluation or interpretation.

The radio 304 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers are in turn coupled to one or more antennas. For example, in some implementations, the wireless communication device 300 can include or be coupled with multiple transmit antennas (each with a corresponding transmit chain) and multiple receive antennas (each with a corresponding receive chain). The symbols output from the modem 302 are provided to the radio 304, which then transmits the symbols via the coupled antennas. Similarly, symbols received via the antennas are obtained by the radio 304, which then provides the symbols to the modem 302.

The processor 306 can include an intelligent hardware block or device such as, for example, a processing core, a processing block, a central processing unit (CPU), a microcontroller, an application-specific integrated circuit (ASIC), or a programmable logic device (PLD) such as a field programmable gate array (FPGA), among other possibilities. The processor 306 processes information received through the radio 304 and the modem 302, and processes information to be output through the modem 302 and the radio 304 for transmission through the wireless medium. For example, the processor 306 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 306 may generally control the modem 302 to cause the modem to perform various operations described above.

The memory 304 can include random access memory (RAM) and read-only memory (ROM). The memory 304 also can store processor- or computer-executable software (SW) code containing instructions that, when executed by the processor 306, cause the processor to perform various operations described herein for wireless communication, including the generation, transmission, reception and interpretation of MPDUs, frames or packets.

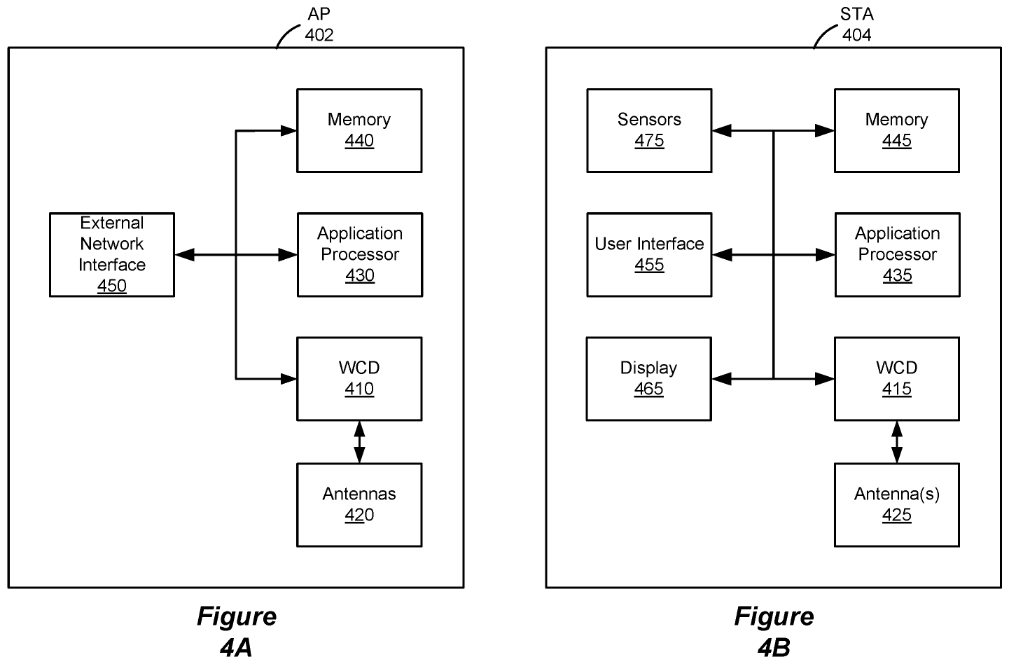

FIG. 4A shows a block diagram of an example AP 402. For example, the AP 402 can be an example implementation of the AP 102 described with reference to FIG. 1. The AP 402 includes a wireless communication device (WCD) 410. For example, the wireless communication device 410 may be an example implementation of the wireless communication device 300 described with reference to FIG. 3. The AP 402 also includes multiple antennas 420 coupled with the wireless communication device 410 to transmit and receive wireless communications. In some implementations, the AP 402 additionally includes an application processor 430 coupled with the wireless communication device 410, and a memory 440 coupled with the application processor 430. The AP 402 further includes at least one external network interface 450 that enables the AP 402 to communicate with a core network or backhaul network to gain access to external networks including the Internet. For example, the external network interface 350 may include one or both of a wired (for example, Ethernet) network interface and a wireless network interface (such as a WWAN interface). Ones of the aforementioned components can communicate with other ones of the components directly or indirectly, over at least one bus.

FIG. 4B shows a block diagram of an example STA 404. For example, the STA 404 can be an example implementation of the STA 104 described with reference to FIG. 1. The STA 404 includes a wireless communication device 415. For example, the wireless communication device 415 may be an example implementation of the wireless communication device 300 described with reference to FIG. 3. The STA 404 also includes one or more antennas 425 coupled with the wireless communication device 415 to transmit and receive wireless communications. The STA 404 additionally includes an application processor 435 coupled with the wireless communication device 415, and a memory 445 coupled with the application processor 435. In some implementations, the STA 404 further includes a user interface (UI) 455 (such as a touchscreen or keypad) and a display 465, which may be integrated with the UI 455 to form a touchscreen display. In some implementations, the STA 404 may further include one or more sensors 475 such as, for example, one or more inertial sensors, accelerometers, temperature sensors, pressure sensors, or altitude sensors. Ones of the aforementioned components can communicate with other ones of the components directly or indirectly, over at least one bus.

As described above, to increase the throughput for a given range, or to enable a greater range for a given throughput, it may be desirable to increase the number N_{SS} of spatial streams used when performing beamforming to transmit data to another wireless communication device. However, some wireless communication devices may not be capable of transmitting as many spatial streams as they have antennas. For example, suppose that a first wireless communication device has N_{Tx}=8 antennas available for transmission, and that a second wireless communication device has N_{Rx}=8 antennas available for reception. In such an example, it is theoretically possible for the first wireless communication device to transmit N_{SS}=N_{Tx}=N_{Rx}=8 spatial streams to the second wireless communication device, and for the second wireless communication device to decompose and process all of the spatial streams. However, in actual implementation, the second wireless communication device may possess hardware, firmware or software capable of only processing a limited number N_{SS} of spatial streams, for example, N_{SS}=4 spatial streams, although it has N_{Rx}=8 antennas and can determine an N_{Tx}×N_{Rx} (8×8) channel estimate. For example, the second wireless communication device may be able to perform a channel decomposition of only the limited number N_{SS}=4 of spatial streams. As such, the second wireless communication device may indicate to the first wireless communication device, for example, during an association operation, that it only supports the limited number N_{SS} of spatial streams. Consequently, the first wireless communication device will not use more than this limited number N_{SS} of spatial streams when transmitting to the second wireless communication device. In the preceding example, this restriction represents an underutilization of four of the available dimensions of the N_{Tx}×N_{Rx} (8×8) MIMO channel.

Various implementations relate generally to beamforming techniques, and more particularly, to techniques for obtaining and providing channel feedback. In some implementations, a beamformee provides channel feedback to a beamformer that enables the beamformer to construct and independently precode two or more different sets of spatial streams for transmission to the beamformee. The independent precoding of the different sets of spatial streams ensures that the decodings of the different sets of spatial streams may be decoupled from one another at the beamformee. To provide the channel feedback, the beamformee partitions a channel estimate into two or more sub-estimates prior to performing a channel decomposition. In some implementations, the beamformee determines null-space-based projections of the sub-estimates before performing the channel decomposition. The determination of the null-space-based projections enables the beamformee to perform independent decompositions of the multiple channel sub-estimates to determine multiple respective feedback matrices, which are then assembled to provide the channel feedback to the beamformer. The channel feedback is then reconstructed and disassembled by the beamformer to perform the independent precoding of the different sets of spatial streams.

Particular implementations of the subject matter described in this disclosure can be implemented to realize one or more of the following potential advantages. In some implementations, the described techniques can be used to increase the throughput for a given range, or to enable a greater range for a given throughput, by increasing the number N_{SS} of spatial streams that may be used for beamforming.

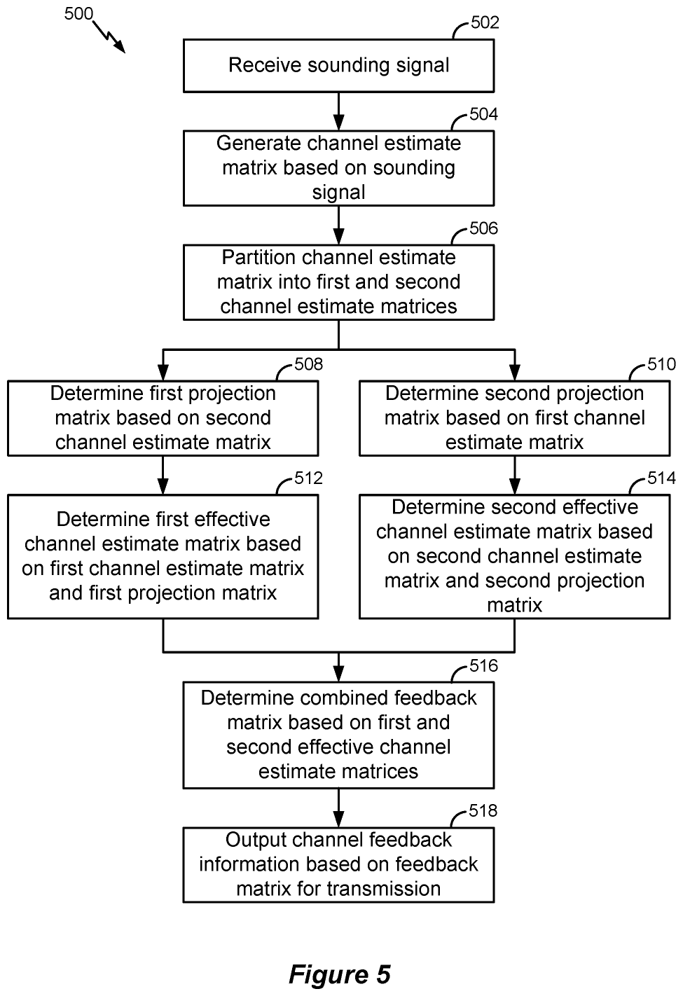

FIG. 5 shows a flowchart illustrating an example process 500 for a first wireless communication device to provide channel feedback information to a second wireless communication device according to some implementations. For example, the first wireless communication device may be configured as a beamformee and the second wireless communication device may be configured as a beamformer. In some implementations, the process 500 may be performed by a first wireless communication device such as the wireless communication device 300 described above with reference to FIG. 3. In some such implementations, the process 500 may be performed by a first wireless communication device operating within an AP, such as one of the APs 102 and 402 described above with reference to FIGS. 1 and 4A, respectively. In some other such implementations, the process may be performed by a first wireless communication device operating within a STA, such as one of the STAs 104 and 404 described above with reference to FIGS. 1 and 4B, respectively. For example, in some scenarios, the first wireless communication device may be operating as, or within, a first AP and the second wireless communication device may be operating as, or within, a different second AP. For example, the first AP may serve as a backhaul to, or a repeater for, the second AP. In some other scenarios, the first wireless communication device may be operating as, or within, a STA and the second wireless communication device may be operating as, or within, an associated AP.

The process 500 begins in block 502 with receiving a sounding signal from the second wireless communication device. In some implementations, the sounding signal is transmitted as a null data packet (NDP). The second wireless communication device may transmit the sounding signal using N_{Tx} antennas and the first wireless communication device may receive the sounding signal in block 502 using N_{Rx} antennas. The sounding signal generally includes multiple long training fields (LTFs) where the number of LTFs is based on N_{Tx}. In block 504, the process 500 proceeds with generating a channel estimate H based on the sounding signal, and more specifically, based on the LTFs. Because the sounding signal was transmitted via N_{Tx} antennas and received via N_{Rx} antennas, the first wireless communication device generates an N_{Rx}×N_{Tx} channel estimate matrix H, as shown below in equation (1) where, for didactic purposes, N_{Tx}=8 and N_{Rx}=8. While the example is described for didactic purposes, it is contemplated that the techniques disclosed herein can be applied in implementations and scenarios in which any number of transmit antennas and any number of receive antennas are employed.

$$H = [ \begin{matrix}{H}_{11} & {H}_{12} & {H}_{13} & {H}_{14} & {H}_{15} & {H}_{16} & {H}_{17} & {H}_{18} \\ {H}_{21} & {H}_{22} & {H}_{23} & {H}_{24} & {H}_{25} & {H}_{26} & {H}_{27} & {H}_{28} \\ {H}_{31} & {H}_{32} & {H}_{33} & {H}_{34} & {H}_{35} & {H}_{36} & {H}_{37} & {H}_{38} \\ {H}_{41} & {H}_{42} & {H}_{43} & {H}_{44} & {H}_{45} & {H}_{46} & {H}_{47} & {H}_{48} \\ {H}_{51} & {H}_{52} & {H}_{53} & {H}_{54} & {H}_{55} & {H}_{56} & {H}_{57} & {H}_{58} \\ {H}_{61} & {H}_{62} & {H}_{63} & {H}_{64} & {H}_{65} & {H}_{66} & {H}_{67} & {H}_{68} \\ {H}_{71} & {H}_{72} & {H}_{73} & {H}_{74} & {H}_{75} & {H}_{76} & {H}_{77} & {H}_{78} \\ {H}_{81} & {H}_{82} & {H}_{83} & {H}_{84} & {H}_{85} & {H}_{86} & {H}_{87} & {H}_{88}\end{matrix} ] \qquad ( 1 )$$

In block 506, the process 500 proceeds with partitioning the channel estimate matrix H into a first channel estimate matrix H₁ and a second channel estimate matrix H₂. In some implementations, the first wireless communication device will receive only N_{SS} spatial streams when receiving a subsequent beamformed transmission from the second wireless communication device. In such instances, the first wireless communication device may, in block 506, partition only the first N_{SS} rows of the channel estimate matrix H into the first channel estimate matrix H₁ and the second channel estimate matrix H₂. For example, the first wireless communication device may partition the channel estimate matrix into a first set of N_{SS1} rows and a second set of N_{SS2}, rows, where the first set of N_{SS1} rows defines the first channel estimate matrix H₁, where the second set of N_{SS2} rows defines the second channel estimate matrix H₂, and where N_{SS1}+N_{SS2}, =N_{SS}, as shown in equations (2) and (3) below.

$$\begin{matrix}{H}_{1} = [ \begin{matrix}{H}_{11} & {H}_{12} & {H}_{13} & {H}_{14} & {H}_{15} & {H}_{16} & {H}_{17} & {H}_{18} \\ {H}_{21} & {H}_{22} & {H}_{23} & {H}_{24} & {H}_{25} & {H}_{26} & {H}_{27} & {H}_{28} \\ {H}_{31} & {H}_{32} & {H}_{33} & {H}_{34} & {H}_{35} & {H}_{36} & {H}_{37} & {H}_{38} \\ {H}_{41} & {H}_{42} & {H}_{43} & {H}_{44} & {H}_{45} & {H}_{46} & {H}_{47} & {H}_{48}\end{matrix} ] & ( 2 ) \\ {H}_{2} = [ \begin{matrix}{H}_{51} & {H}_{52} & {H}_{53} & {H}_{54} & {H}_{55} & {H}_{56} & {H}_{57} & {H}_{58} \\ {H}_{61} & {H}_{62} & {H}_{63} & {H}_{64} & {H}_{65} & {H}_{66} & {H}_{67} & {H}_{68} \\ {H}_{71} & {H}_{72} & {H}_{73} & {H}_{74} & {H}_{75} & {H}_{76} & {H}_{77} & {H}_{78} \\ {H}_{81} & {H}_{82} & {H}_{83} & {H}_{84} & {H}_{85} & {H}_{86} & {H}_{87} & {H}_{88}\end{matrix} ] & ( 3 )\end{matrix}$$

In equations (2) and (3) shown above, N_{SS1}=4 and N_{SS2}=4. However, while N_{SS1}=N_{SS2} in this example, it is contemplated that the techniques disclosed herein can be applied in implementations and scenarios in which N_{SS1}≠N_{SS2}. In some implementations, the optimal values of N_{SS1} and N_{SS2}, for a given total number of spatial streams N_{SS} are determined a priori. For example, the first wireless communication device may determine the optimal values of N_{SS1} and N_{SS2} for each number N_{SS} of spatial streams it supports and communicate the optimal values to the second wireless communication device during an association operation. As another example, the second wireless communication device may determine the values of N_{SS1} and N_{SS2} for each number of spatial streams it supports and communicate the values to the first wireless communication device during an association operation. As another example, both the first and the second wireless communication devices may determine values for N_{SS1} and N_{SS2}, exchange the values with one another, and negotiate to determine a final set of values for N_{SS1} and N_{SS2}. In some implementations, the values for N_{SS1} and N_{SS2} may be stored in a lookup table (LUT) in a memory of the first wireless communication device. The first wireless communication device may query the LUT based on the number N_{SS} of spatial streams to be subsequently used by the second wireless device in transmitting a beamformed communication to the first wireless communication device. The second wireless device may include the same LUT as the first wireless communication device.

In blocks 508 and 510, the process 500 proceeds with determining a first projection matrix P₁ based on the second channel estimate matrix H₂, and determining a second projection matrix P₂ based on the first channel estimate matrix H₁, respectively. The first and the second projection matrices P₁ and P₂ are used to decouple the first and the second channel estimates H₁ and H₂. In some implementations, the first wireless communication device determines the first projection matrix P₁ from the null space of the second channel estimate matrix H₂ in block 508 as shown in equation (4) below. Similarly, in such implementations, the first wireless communication device may determine the second projection matrix P₂ from the null space of the first channel estimate matrix H₁ in block 510 as shown in equation (5) below. Continuing the example above, the resulting projection matrix P₁ consists of N_{Tx}=8 rows and N_{Tx}−N_{SS2}=4 columns. Similarly, the resulting projection matrix P₂ consists of N_{Tx}=8 rows and N_{Tx}−N_{SS1}=4 columns.

P₁=null(H₂) (4)

P₂=null(H₁) (5)

In blocks 512 and 514, the process 500 proceeds with determining a first effective channel estimate matrix H_{Eff1} based on the first channel estimate matrix H₁ and the first projection matrix P₁, and determining a second effective channel estimate matrix H_{Eff2} based on the second channel estimate matrix H₂ and the second projection matrix P₂, respectively. In some implementations, the first wireless communication device determines the first effective channel estimate matrix H_{Eff1} by multiplying the first channel estimate matrix H₁ and the first projection matrix P₁ in block 512 as shown in equation (6) below, and determines the second effective channel estimate matrix H_{Eff2} by multiplying the second channel estimate matrix H₂ and the second projection matrix P₂ as shown in equation (7) below. Continuing the example above, the first effective channel estimate H_{Eff1} consists of N_{SS1}=4 rows and N_{Tx}−N_{SS2}=4 columns, and the second effective channel estimate H_{Eff2} consists of N_{SS2}=4 rows and N_{Tx}−N_{SS1}=4 columns.

H_{Eff1}=H₁P₁ (6)

H_{Eff2}=H₂P₂ (7)

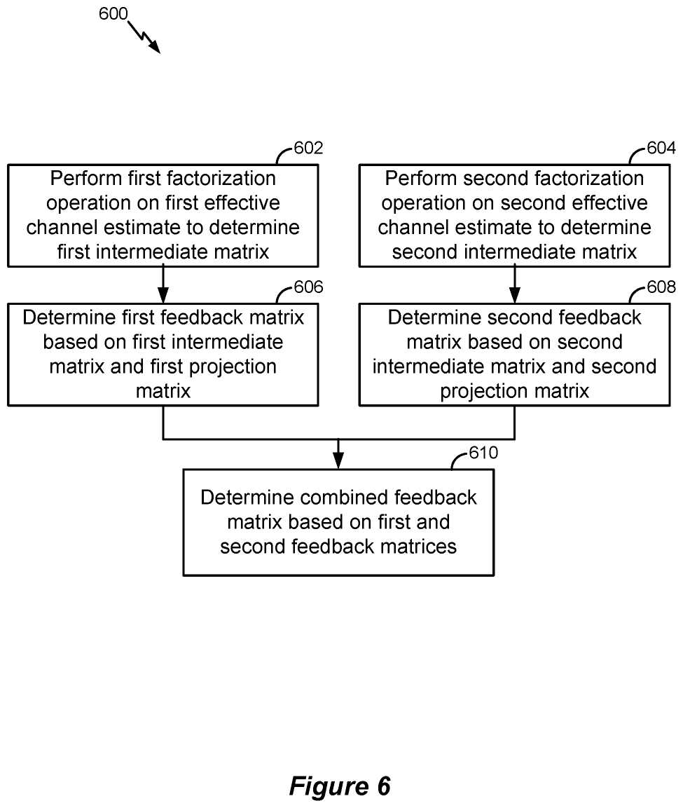

In block 516, the process 500 proceeds with determining a combined feedback matrix Z based on the first effective channel estimate H_{Eff1} and the second effective channel estimate H_{Eff2} (for example, as described with reference to the process 600 of FIG. 6).

In block 518, the process 500 proceeds with outputting channel feedback information based on the combined feedback matrix Z for transmission to the second wireless communication device. For example, the first wireless communication device can output the channel feedback information for transmission to the second wireless communication device via a radio and one or more coupled antennas. In some implementations, the first wireless communication device is configured to, in block 518, first compress the combined feedback matrix Z to generate compressed feedback before outputting the compressed feedback as channel feedback information. For example, to compress the combined feedback matrix Z in block 518, the first wireless communication device may be configured to perform a Givens rotation operation on the elements of the combined feedback matrix Z to generate quantized angles representative of the combined feedback matrix Z. The channel feedback information may include the quantized angles. In some implementations, the channel feedback information is output in block 518 in a feedback packet that includes a High Efficiency (HE) Compressed Beamforming/Channel quality indication (CQI) frame, which includes a compressed beamforming (CBF) report field that includes the quantized angles. In some implementations, the HE Compressed Beamforming/CQI frame further comprises an average signal-to-noise ratio (SNR) for each spatial stream.

In some implementations, the channel feedback information additionally includes at least one of an indication of N_{SS1} or an indication of N_{SS2}, for example, so that the second wireless communication device is aware of how the first wireless communication device partitioned the channel estimate to obtain the compressed feedback. In some implementations, the indication of N_{SS1} or N_{SS2} may be included within a MIMO control field of the feedback packet. For example, the MIMO control field may be generated to include one of a number of possible bit sequences indicating the values of N_{SS1} and N_{SS2}. In some implementations implementing very high throughput (VHT) communications as defined by the IEEE 802.11-2016 specification, the first wireless communication device may select one of four 2-bit sequences to include in the MIMO control field based on whether, and how, the channel estimate matrix H was partitioned. Table (1) below shows an example in which the values of N_{SS1} and N_{SS2}, are defined for various values of N_{SS}. For example, the first wireless communication device may generate the MIMO control field to include the bit sequence “00” to indicate that it did not partition the channel estimate. The first wireless communication device may generate the MIMO control field to include the bit sequences “01,” “10” or “11” in instances in which it did partition the channel estimate H to indicate the values of N_{SS1} and N_{SS2}, relative to the total number N_{SS} of spatial streams. For example, if the bit sequence “01” is identified, and 6 spatial streams are used, then the second wireless communication device will know that N_{SS1}=4 and N_{SS2}=2.

TABLE 1

| | (N_{SS1}, N_{SS2}) | (N_{SS1}, N_{SS2}) | (N_{SS1}, N_{SS2}) | (N_{SS1}, N_{SS2}) |
|---|---|---|---|---|
| Big | for | for | for | for |
| Sequence | N_{SS} = 5 | N_{SS} = 6 | N_{SS} = 7 | N_{SS} = 8 |
| 00 | N/A | N/A | N/A | N/A |
| 01 | (4, 1) | (4, 2) | (4, 3) | (4, 4) |
| 10 | (3, 2) | (3, 3) | (3, 4) | N/A |
| 11 | (2, 3) | (2, 4) | N/A | N/A |

As another example, in some implementations implementing high efficiency (HE) communications as defined by the IEEE 802.11ax amendment, the first wireless communication device may select one of multiple 4-bit sequences to include in the MIMO control field based on whether, and how, the channel estimate matrix H was partitioned. Table (2) below shows an example in which the values of N_{SS1} and N_{SS2} are defined for various 4-bit sequences. For example, the first wireless communication device may generate the MIMO control field to include the bit sequence “0111” to indicate that N_{SS1}=2 and N_{SS2}, =4. As another example, the first wireless communication device may generate the MIMO control field to include the bit sequence “1111” to indicate N_{SS1}=4 and N_{SS2}=4.

TABLE 2

| Bit Sequence | N_{SS1} | N_{SS2} |
|---|---|---|
| 0011 | 1 | 4 |
| 0110 | 2 | 3 |
| 0111 | 2 | 4 |
| 1001 | 3 | 2 |
| 1010 | 3 | 3 |
| 1011 | 3 | 4 |
| 1100 | 4 | 1 |
| 1101 | 4 | 2 |
| 1110 | 4 | 3 |
| 1111 | 4 | 4 |

While not described as being a part of the process 500, in some implementations, prior to receiving the sounding signal, the first wireless communication device transmits an indication to the second wireless communication device indicating that the first wireless communication device includes capabilities to support the operations of the process 500. For example, the first wireless communication device may signal its support of the process 500 during an association operation in which the first wireless communication device associates with the second wireless device.

FIG. 6 shows a flowchart illustrating an example process 600 for determining a combined feedback matrix according to some implementations. For example, the process 600 may be implemented by the first wireless communication device described with reference to FIG. 5 to determine the combined feedback matrix Z in block 516 of the process 500. In some implementations, after the performance of blocks 512 and 514 of the process 500, the process 600 begins in blocks 602 and 604 with performing a first factorization operation on the first effective channel estimate matrix H_{Eff1} to determine a first intermediate matrix V₁, and performing a second factorization operation on the second effective channel estimate matrix H_{Eff2} to determine a second intermediate matrix V₂, respectively.

In some such implementations, the factorization operations performed in blocks 602 and 604 are singular value decomposition (SVD) operations. For example, the first wireless communication device may be configured to perform a first SVD operation on the first effective channel estimate matrix H_{Eff1} in block 602 to generate the first intermediate matrix V₁ (a unitary matrix), and to perform a second SVD operation on the second effective channel estimate matrix H_{Eff2} in block 604 to generate the second intermediate matrix V₂ (a unitary matrix), as shown in equations (8) and (9) below, respectively. Continuing the example above, the first feedback matrix V₁ consists of N_{Tx}−N_{SS2}=4 rows and N_{SS1}=4 columns, and the second feedback matrix V₂ consists of N_{Tx}−N_{SS1}=4 rows and N_{SS2}=4 columns.

(U₁S₁V₁)=svd(H_{Eff1}) (8)

(U₂S₂V₂)=svd(H_{Eff2}) (9)

In block 606 the process 600 proceeds with determining a first feedback matrix Z₁ based on the first projection matrix P₁ and the first intermediate matrix V₁, for example, by multiplying the first projection matrix P₁ and the first intermediate matrix V₁, as shown in equation (10) below (where the resulting first feedback matrix Z₁ includes N_{Tx} rows and N_{SS1} columns). Similarly, in block 608 the process 600 proceeds with determining a second feedback matrix Z₂ based on the second projection matrix P₂ and the second intermediate matrix V₂, for example, by multiplying the second projection matrix P₂ and the second intermediate matrix V₂ as shown in equation (11) below (where the resulting second precoding matrix Z₂ includes N_{Tx} rows and N_{SS2}, columns).

Z₁=P₁V₁ (10)

Z₂=P₂V₂ (11)

The first wireless communication device may then generate the combined feedback matrix Z in block 610 based on the first feedback matrix Z₁ and the second feedback matrix Z₂. It may be desirable for the combined feedback matrix Z to be an orthonormal block-diagonal matrix so that the first feedback matrix Z₁ and the second feedback matrix Z₂ may be decoupled and reconstructed by the second wireless communication device. To generate an orthonormal block-diagonal feedback matrix Z, the first wireless communication device may be configured to stack the first feedback matrix Z₁ and the second feedback matrix Z₂ to generate a tall orthonormal matrix such that the first and the second feedback matrices do not share any rows or columns in the resultant combined feedback matrix Z, as shown below in equation (12) (where the resulting steering matrix Z includes 2N_{T}, rows and N_{SS} columns).

$$Z = [ \begin{matrix} & & & 0 & … & 0 \\ & {Z}_{1} & & ⋮ & ⋱ & ⋮ \\ & & & 0 & … & 0 \\ 0 & … & 0 & & & \\ ⋮ & ⋱ & ⋮ & & {Z}_{2} & \\ 0 & … & 0 & & & \end{matrix} ] \qquad ( 12 )$$

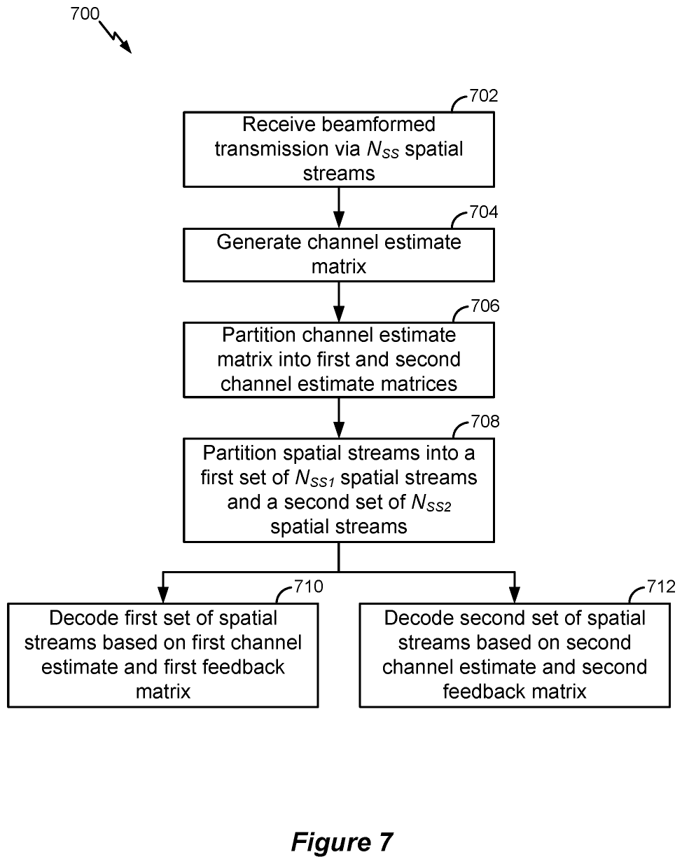

FIG. 7 shows a flowchart illustrating an example process 700 for a first wireless communication device to decode a beamformed transmission received from a second wireless communication device according to some implementations. For example, the first wireless communication device may be configured as a beamformee and the second wireless communication device may be configured as a beamformer. In some implementations, the process 700 may be performed by a first wireless communication device such as the wireless communication device 300 described above with reference to FIG. 3. In some such implementations, the process 700 may be performed by a first wireless communication device operating within an AP, such as one of the APs 102 and 402 described above with reference to FIGS. 1 and 4A, respectively. In some other such implementations, the process may be performed by a first wireless communication device operating within a STA, such as one of the STAs 104 and 404 described above with reference to FIGS. 1 and 4B, respectively. For example, in some scenarios, the first wireless communication device may be operating as, or within, a first AP and the second wireless communication device may be operating as, or within, a different second AP. For example, the first AP may serve as a backhaul to, or a repeater for, the second AP. In some other scenarios, the first wireless communication device may be operating as, or within, a STA and the second wireless communication device may be operating as, or within, an associated AP.

In some implementations, the process 700 begins after the end of the process 500 described with reference to FIG. 5. For example, after the channel feedback information is transmitted to the second wireless communication device, the first wireless communication device may prepare to receive a beamformed transmission from the second wireless communication device. As such, in the example described below, the process 700 begins in block 702 with receiving a beamformed transmission from the second wireless communication device. The beamformed transmission includes at least one packet received via N_{SS} spatial streams. In block 704, the process 700 proceeds with generating a channel estimate H_{B} based on the beamformed transmission received in block 702. In block 706, the process 700 proceeds with partitioning the channel estimate matrix H_{B} into a first channel estimate matrix H_{B1} and a second channel estimate matrix H_{B2}. For example, the first wireless communication device may partition the channel estimate matrix into a first set of N_{SS1} rows and a second set of N_{SS2} rows, where the first set of N_{SS1} rows defines the first channel estimate matrix H_{B1}, where the second set of N_{SS2} rows defines the second channel estimate matrix H_{B2}, and where N_{SS1}+N_{SS2}=N_{SS}.

In block 708, the process 700 proceeds with partitioning the spatial streams into a first set of N_{SS1} spatial streams and a second set of N_{SS2} spatial streams, wherein N_{SS1}+N_{SS2}=N_{SS}. The design of the combined feedback matrix Z, and its provision to the second wireless communication device, enables the second wireless communication device to precode the first and the second sets of spatial streams such that the decoding of the first set of N_{SS1} spatial streams may be decoupled from the decoding of the second set of N_{SS2} spatial streams. In blocks 710 and 712, the process 700 proceeds with decoding the first set of N_{SS1} spatial streams based on the first channel estimate matrix H_{B1} and the first feedback matrix Z₁, and decoding the second set of N_{SS2} spatial streams based on the second channel estimate matrix H_{B2} and the second feedback matrix Z₂, respectively. In some implementations, the first wireless communication device may then spatially demultiplex (combine) the decoded bits from all N_{SS} spatial streams, descramble the combined bits, and provide the descrambled bits to the MAC layer for further processing.

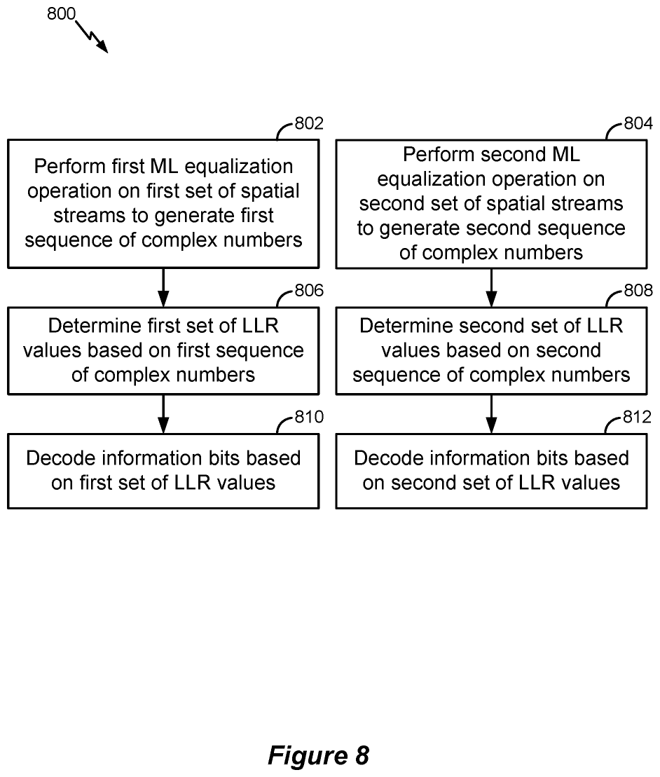

FIG. 8 shows a flowchart illustrating an example process 800 for decoding sets of spatial streams according to some implementations. For example, the process 800 may be implemented by the first wireless communication device described with reference to FIG. 7 to decode the first and the second sets of spatial streams in blocks 710 and 712 of the process 700. In some implementations, after the spatial streams are partitioned into the first and second sets of spatial streams, the process 800 begins to blocks 802 and 804. For example, in block 802, the first wireless communication device performs a first ML equalization operation on the first set of N_{SS1} spatial streams based on the first channel estimate matrix H_{B1} (obtained in block 706 of the process 700) and the first feedback matrix Z₁ (obtained in block 606 of the process 600) to generate a first sequence of complex numbers. Similarly, in block 804, the first wireless communication device performs a second ML equalization operation on the second set of N_{SS2}, spatial streams based on the second channel estimate matrix H_{B2} (obtained in block 706 of the process 700) and the second feedback matrix Z₂ (obtained in block 608 of the process 600) to generate a second sequence of complex numbers.

The ability to perform two independent ML equalization operations is based at least in part on the fact that the first projection matrix P₁ is obtained from the null space of the second channel estimate matrix H₂ in block 508 of the process 500, and the second projection matrix P₂ is obtained from the null space of the first channel estimate matrix H₁ in block 510 of the process 500. For example, equation (13) below shows the received vector y as a function of the channel estimates H_{B1} and H_{B2}, the feedback matrices Z₁ and Z₂, the transmit vector xₙ output from the second wireless communication device, and a noise vector nₙ.

$$y = [ \begin{matrix}{y}_{1} \\ {y}_{2}\end{matrix} ] = [ \begin{matrix}{H}_{B 1} \\ {H}_{B 2}\end{matrix} ] [ \begin{matrix}{Z}_{1} & {Z}_{2}\end{matrix} ] [ \begin{matrix}{x}_{1} \\ {x}_{2}\end{matrix} ] + [ \begin{matrix}{n}_{1} \\ {n}_{2}\end{matrix} ] = \\ [ \begin{matrix}{H}_{B 1} {P}_{1} {V}_{1} & {H}_{B 1} {P}_{2} {V}_{2} \\ {H}_{B 2} {P}_{1} {V}_{1} & {H}_{B 2} {P}_{2} {V}_{2}\end{matrix} ] [ \begin{matrix}{x}_{1} \\ {x}_{2}\end{matrix} ] + [ \begin{matrix}{n}_{1} \\ {n}_{2}\end{matrix} ] \qquad ( 13 )$$

Because H_{B1}P₂ is assumed to be 0 (because the first channel estimate matrix H_{B1} obtained in block 706 of the process 700 is assumed to be approximately the same as the first channel estimate matrix H₁ obtained in block 506 of the process 500, and because the second projection matrix P₂ is obtained from the null space of the first channel estimate matrix H₁ obtained in block 506), and because H_{B2}P₁ is assumed to be 0 (because the second channel estimate matrix H_{B2} obtained in block 706 of the process 700 is assumed to be approximately the same as the second channel estimate matrix H₂ obtained in block 506 of the process 500, and because the first projection matrix P₁ is obtained from the null space of the second channel estimate matrix H₂ obtained in block 506), the received component vectors can be expressed as equations (14) and (15) below, where x₁ represents the transmit sub-vector for the first set of N_{SS1} spatial streams and x₂ represents the transmit sub-vector for the second set of N_{SS2} spatial streams.

y₁=H_{B1}P₁V₁x₁+n₁=H_{B1}Z₁x₁+n₁ (14)

y₂=H_{B2}P₂V₂x₂+n₂=H_{B2}Z₂x₂+n₂ (15)

As such, a first ML equalization operation may be performed in block 802 on the first set of N_{SS1} spatial streams based on the first channel estimate matrix H_{B1} and the first feedback matrix Z₁ to generate the first sequence of complex numbers, and a second separate ML equalization operation may be performed in block 804 on the second set of N_{SS2} spatial streams based on the second channel estimate matrix H_{B2} and the second feedback matrix Z₂ to generate a second sequence of complex numbers.

After performing the first ML equalization operation in block 802, the process 800 may proceed in block 806 with determining a first set of logarithm likelihood ratio (LLR) values based on the first sequence of complex numbers, for example, on a per bit position, per subcarrier, per stream basis. Similarly, after performing the second ML equalization operation in block 804, the process 800 may proceed in block 808 with determining a second set of LLR values based on the second sequence of complex numbers on a per bit position, per subcarrier, per stream basis. In blocks 810 and 812, the process 800 then proceeds with decoding information bits for the first set of N_{SS1} spatial streams based on the first set of LLR values, and decoding information bits for the second set of N_{SS2} spatial streams based on the second set of LLR values, respectively.

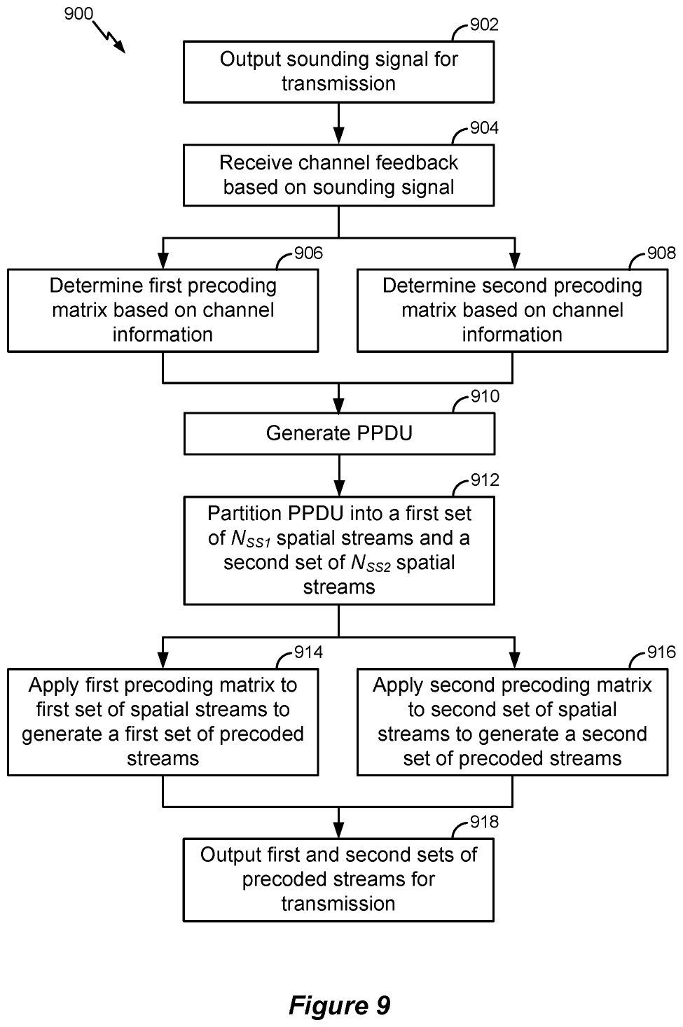

FIG. 9 shows a flowchart illustrating an example process 900 for a first wireless communication device to generate a beamformed transmission for a second wireless communication device according to some implementations. For example, the first wireless communication device may be configured as a beamformer and the second wireless communication device may be configured as a beamformee. In some implementations, the process 900 may be performed by a first wireless communication device such as the wireless communication device 300 described above with reference to FIG. 3. In some such implementations, the process 900 may be performed by a first wireless communication device operating within an AP, such as one of the APs 102 and 402 described above with reference to FIGS. 1 and 4A, respectively. For example, in some scenarios, the first wireless communication device may be operating as, or within, a first AP and the second wireless communication device may be operating as, or within, a different second AP. For example, the second AP may serve as a backhaul to, or a repeater for, the first AP. In some other scenarios, the first wireless communication device may be operating as, or within, an AP and the second wireless communication device may be operating as, or within, a STA.

In some implementations, the process 900 begins in block 902 with outputting, for transmission to the second wireless communication device, a sounding signal. For example, the first wireless communication device can output the sounding signal for transmission to the second wireless communication device via N_{Tx} coupled antennas. In some implementations, the sounding signal is generated and transmitted as an NDP. The sounding signal generally includes multiple LTFs where the number of LTFs is based on N_{Tx}.

After the sounding signal is transmitted in block 902, the first wireless communication device waits for channel feedback from the second wireless communication device. In block 904, the first wireless communication device receives the channel feedback information based on the sounding signal. In some implementations, the channel feedback information includes compressed feedback in the form of, for example, quantized angles obtained through a Givens rotation operation. In some implementations, the channel feedback information is received in block 904 in a feedback packet that includes an HE Compressed Beamforming/CQI frame, which includes a CBF report field that includes the quantized angles. In some implementations, the HE Compressed Beamforming/CQI frame further comprises an average SNR for each spatial stream In some implementations, the channel feedback information additionally includes at least one of an indication of N_{SS1} or an indication of N_{SS2}, for example, so that the first wireless communication device is aware of how the second wireless communication device partitioned the channel estimate to obtain the compressed feedback. In some such implementations, the indication of N_{SS1} or N_{SS2} may be included within a MIMO control field of the feedback packet. For example, the MIMO control field can include one of multiple possible bit sequences selected by the second wireless communication device as described above with reference to Tables (1) and (2).

In blocks 906 and 908, the process 900 proceeds with determining a first precoding matrix Z₁ for a first set of N_{SS1} spatial streams and a second precoding matrix Z₂ for a second set of N_{SS2} spatial streams, respectively, based on the channel feedback information. For example, blocks 906 and 908 may include decompressing the compressed feedback received in block 904 to generate a steering matrix Z, and partitioning the steering matrix Z to determine the first and the second precoding matrices Z₁ and Z₂, respectively. In some implementations, the steering matrix is a row-stacked matrix as shown in equation (16) below.

Z=[Z₁Z₂] (16)

In block 910, the process 900 proceeds with generating at least one PPDU including data for the second wireless communication device. For example, the first wireless communication device may generate an A-MPDU that includes the data, and encapsulate the A-MPDU in a PPDU for transmission to the second wireless communication device. In block 912, the process 900 proceeds with partitioning the at least one PPDU into N_{SS} spatial streams, and more specifically, into a first set of N_{SS1} spatial streams and a second set of N_{SS2} spatial streams. The design of the steering matrix Z enables the first wireless communication device to precode the first and the second sets of spatial streams separately such that the decoding of the first set of N_{SS1} spatial streams may be decoupled from the decoding of the second set of N_{SS2} spatial streams at the second wireless communication device. In blocks 914 and 916, the process 900 proceeds with applying the first precoding matrix Z₁ to the first set of N_{SS1} spatial streams to precode the associated symbols to generate a first set of precoded streams, and applying the second precoding matrix Z₂ to the second set of N_{SS2} spatial streams to precode the associated symbols to generate a second set of precoded streams, respectively.

In block 918, the first wireless communication device outputs the first and the second sets of precoded streams for transmission to the second wireless communication device. To output the first and the second sets of precoded streams, the first wireless communication device may be configured to first multiplex the first and the second sets of precoded streams to generate a multiplexed stream, transform the modulated symbols in the multiplexed stream via an IFFT, and apply various digital signal processing, digital-to-analog conversion, and frequency upconversion. The first wireless communication device may then provide the resultant analog signals to a radio, which may then amplify, otherwise process, and output the analog signals for transmission to the second wireless communication device via, for example, N_{Tx} coupled antennas.

While not described as being a part of the process 900, in some implementations, prior to generating and transmitting the sounding signal, the first wireless communication device receives an indication from the second wireless communication device indicating that the second wireless communication device includes capabilities to support the operations of one or more of the processes 500, 600, 700, 800 and 900 described with reference to FIGS. 5-9, respectively. For example, the second wireless communication device may signal its support during an association operation in which the second wireless communication device associates with the first wireless device.

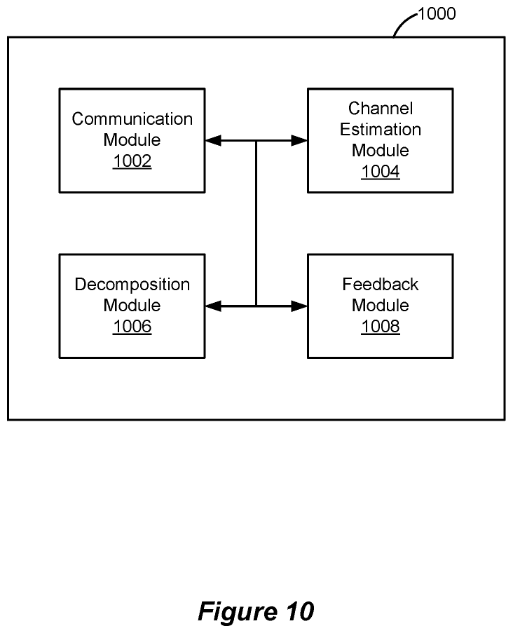

FIG. 10 shows a block diagram of an example wireless communication device 1000 for use in wireless communication according to some implementations. In some implementations, the wireless communication device 1000 is configured to provide channel feedback information to a second wireless communication device. For example, the wireless communication device 1000 may be configured as a beamformee and the second wireless communication device may be configured as a beamformer. In some implementations, the wireless communication device 1000 is configured to perform the processes 500 or 600 described above with reference to FIGS. 5 and 6, respectively. In some implementations, the wireless communication device 1000 is further configured to perform the processes 700 or 800 described above with reference to FIGS. 7 and 8, respectively. In some implementations, the wireless communication device 1000 can be an example implementation of the wireless communication device 300 described above with reference to FIG. 3. In some implementations, the wireless communication device 1000 can be configured to operate within an AP, such as one of the APs 102 and 402 described above with reference to FIGS. 1 and 4A, respectively. In some other such implementations, the wireless communication device 1000 can be configured to operate within a STA, such as one of the STAs 104 and 404 described above with reference to FIGS. 1 and 4B, respectively. For example, in some scenarios, the wireless communication device 1000 may be operating as, or within, a first AP and the second wireless communication device may be operating as, or within, a different second AP. For example, the first AP may serve as a backhaul to, or a repeater for, the second AP. In some other scenarios, the wireless communication device 1000 may be operating as, or within, a STA and the second wireless communication device may be operating as, or within, an associated AP. For example, the wireless communication device 1000 can be a chip, SoC, chipset, package or device that includes at least one processor and at least one modem (for example, a Wi-Fi (IEEE 802.11) modem or a cellular modem). In other instances, the wireless communication device 1000 can be a STA or an AP that includes such a chip, SoC, chipset, package or device, as well as at least one transmitter, at least one receiver, and at least one antenna.

The wireless communication device 1000 includes a communication module 1002, a channel estimation module 1004, a decomposition module 1006, and a feedback module 1008. Portions of one or more of the modules 1002, 1004, 1006 and 1008 may be implemented at least in part in hardware or firmware. For example, the communication and channel estimation modules 1002 and 1004, respectively, may be implemented at least in part by one or more modems (such as the modem 302). In some implementations, at least some of the modules 1002, 1004, 1006 and 1008 are implemented at least in part as software stored in a memory (such as the memory 308). For example, portions of one or more of the modules 902, 904, 906 and 908 can be implemented as non-transitory instructions (or “code”) executable by at least one processor (such as the processor 306) to perform the functions or operations of the respective modules. For example, the code may enable the processor 306 to implement a MAC layer that, in turn, implements portions of, or controls, one or more of the modules 1002, 1004, 1006 or 1008.

The communication module 1002 includes a reception sub-module configured to receive wireless packets obtained by multiple coupled antennas and a radio over a wireless medium. For example, the communication module 1002 is configured to receive sounding signals, such as NDPs, from a second wireless communication device. The communication module 1002 is further configured to receive SU or MU beamformed transmissions from the second wireless communication device. The communication module 1002 also includes a transmission sub-module configured to output wireless packets for transmission by a coupled radio and multiple antennas over the wireless medium. For example, the communication module 1002 is configured to output wireless packets that include channel feedback information for transmission to the second wireless communication device. In some implementations, the channel feedback information is output in a feedback packet that includes an HE Compressed Beamforming/CQI frame, which includes a CBF report field that includes the channel feedback information.

The channel estimation module 1004 is configured to generate a channel estimate matrix H based on a packet received by the communication module 1002. For example, the packet may be a sounding signal or a beamformed transmission. The channel estimation module is further configured to partition the channel estimate matrix H into a first channel estimate matrix H₁ and a second channel estimate matrix H₂. In some implementations, the communication module 1002 will receive only N_{SS} spatial streams when receiving a beamformed transmission from the second wireless communication device. In such instances, the channel estimation module 1004 may partition only the first N_{SS} rows of the channel estimate matrix H into the first channel estimate matrix H₁ and the second channel estimate matrix H₂. For example, the channel estimation module 1004 may partition the channel estimate matrix into a first set of N_{SS1} rows and a second set of N_{SS2} rows, where the first set of N_{SS1} rows defines the first channel estimate matrix H₁, where the second set of N_{SS2} rows defines the second channel estimate matrix H₂, and where N_{SS1}+N_{SS2}=N_{SS}.

As described above, in some implementations, the optimal values of N_{SS1} and N_{SS2} for a given total number of spatial streams N_{SS} are determined a priori. For example, the channel estimation module 1004 may determine the optimal values of N_{SS1} and N_{SS2} for each number N_{SS} of spatial streams the wireless communication device 1000 supports and provide the optimal values for transmission to the second wireless communication device during an association operation. As another example, the second wireless communication device may determine the values of N_{SS1} and N_{SS2} for each number of spatial streams it supports and communicate the values to the wireless communication device 1000 during an association operation. As another example, both the channel estimation module 1004 and the second wireless communication devices may determine values for N_{SS1} and N_{SS2}, exchange the values with one another, and negotiate to determine a final set of values for N_{SS1} and N_{SS2}. In some implementations, the values for N_{SS1} and N_{SS2} may be stored in a LUT in a memory of the wireless communication device 1000. The channel estimation module 1004 may query the LUT based on the number N_{SS} of spatial streams to be subsequently used by the second wireless device in transmitting beamformed communications to the wireless communication device 1000. The second wireless device may include the same LUT as the wireless communication device 1000.

The channel estimation module 1004 is additionally configured to determine a first projection matrix P₁ based on the second channel estimate matrix H₂, and to determine a second projection matrix P₂ based on the first channel estimate matrix H₁. As described above, the first and the second projection matrices P₁ and P₂ are used to decouple the first and the second channel estimates H₁ and H₂. In some implementations, the channel estimation module 1004 determines the first projection matrix P₁ from the null space of the second channel estimate matrix H₂. Similarly, in such implementations, the channel estimation module 1004 may determine the second projection matrix P₂ from the null space of the first channel estimate matrix H₁.

The channel estimation module 1004 is further configured to determine a first effective channel estimate matrix H_{Eff1} based on the first channel estimate matrix H₁ and the first projection matrix P₁. Similarly, the channel estimation module 1004 is configured to determine a second effective channel estimate matrix H_{Eff2} based on the second channel estimate matrix H₂ and the second projection matrix P₂. In some implementations, the channel estimation module 1004 determines the first effective channel estimate matrix H_{Eff1} by multiplying the first channel estimate matrix H₁ and the first projection matrix P₁, and determines the second effective channel estimate matrix H_{Eff2} by multiplying the second channel estimate matrix H₂ and the second projection matrix P₂.

The decomposition module 1006 is configured to perform decomposition operations on the first and the second channel estimate matrices H_{Eff1} and H_{Eff2}. For example, the decomposition module 1006 is configured to determine a first intermediate matrix V₁ based on the first effective channel estimate matrix H_{Eff1}, and to determine a second intermediate matrix V₂ based on the second effective channel estimate matrix H_{Eff2}. In some implementations, to determine the first intermediate matrix V₁, the decomposition module 1006 is configured to perform a factorization operation on the first effective channel estimate matrix H_{Eff1}. Similarly, to determine the second intermediate matrix V₂, the decomposition module 1006 is configured to perform a factorization operation on the second effective channel estimate matrix H_{Eff2}. In some such implementations, the decomposition module 1006 is configured to perform factorization operations in the form of SVD operations. For example, the decomposition module 1006 may be configured to perform a first SVD operation on the first effective channel estimate matrix H_{Eff1} to generate the first intermediate matrix V₁ (a unitary matrix), and to perform a second SVD operation on the second effective channel estimate matrix H_{Eff2} to generate the second intermediate matrix V₂ (a unitary matrix).

The feedback module 1008 is configured to generate feedback information based on the first and the second channel estimate matrices H_{Eff1} and H_{Eff2}. For example, the feedback module 1008 may be configured to generate the feedback information based on the factorization operations performed by the decomposition module 1006. In some implementations, the feedback module 1008 is configured to generate a combined feedback matrix Z based on the first intermediate matrix V₁ and the second intermediate matrix V₂. In some implementations, to determine the combined feedback matrix Z, the feedback module 1008 is configured to determine a first feedback matrix Z₁ based on the first projection matrix P₁ and the first intermediate matrix V₁, for example, by multiplying the first projection matrix P₁ and the first intermediate matrix V₁. Similarly, the feedback module 1008 may be configured to determine a second feedback matrix Z₂ based on the second projection matrix P₂ and the second intermediate matrix V₂, for example, by multiplying the second projection matrix P₂ and the second intermediate matrix V₂.

The feedback module 1008 may then generate the combined feedback matrix Z based on the first feedback matrix Z₁ and the second feedback matrix Z₂. As described above, it may be desirable for the combined feedback matrix Z to be an orthonormal block-diagonal matrix so that the first feedback matrix Z₁ and the second feedback matrix Z₂ may be decoupled and reconstructed by the second wireless communication device. To generate an orthonormal block-diagonal feedback matrix Z, the feedback module 1008 may be configured to stack the first feedback matrix Z₁ and the second feedback matrix Z₂ to generate a tall orthonormal matrix such that the first and the second feedback matrices do not share any rows or columns in the resultant combined feedback matrix Z.

The feedback module 1008 is further configured to provide the channel feedback information to the communication module 1002 for subsequent transmission to the second wireless communication device. In some implementations, the feedback module 1008 is configured to first compress the combined feedback matrix Z to generate compressed feedback before outputting the compressed feedback as the channel feedback information. For example, to compress the combined feedback matrix Z, the feedback module 1008 may be configured to perform a Givens rotation operation on the elements of the combined feedback matrix Z to generate quantized angles representative of the combined feedback matrix Z. The channel feedback information may include the quantized angles.

In some implementations, the channel feedback information additionally includes at least one of an indication of N_{SS1} or an indication of N_{SS2}, for example, so that the second wireless communication device is aware of how the channel estimation module 1004 partitioned the channel estimate to obtain the compressed feedback. In some implementations, the indication of N_{SS1} or N_{SS2} may be included within a MIMO control field of the feedback packet output by the communication module 1002. For example, the MIMO control field may be generated to include one of a number of possible bit sequences indicating the values of N_{SS1} and N_{SS2}. In some implementations implementing VHT communications as defined by the IEEE 802.11-2016 specification, the feedback module 908 may select one of four 2-bit sequences to include in the MIMO control field based on whether, and how, the channel estimate matrix H was partitioned. Table (1) above shows an example in which the values of N_{SS1} and N_{SS2}, are defined for various values of N_{SS}. As another example, in some implementations implementing HE communications as defined by the IEEE 802.11ax amendment, the feedback module 908 may select one of multiple 4-bit sequences to include in the MIMO control field based on whether, and how, the channel estimate matrix H was partitioned. Table (2) above shows an example in which the values of N_{SS1} and N_{SS2}, are defined for various 4-bit sequences.

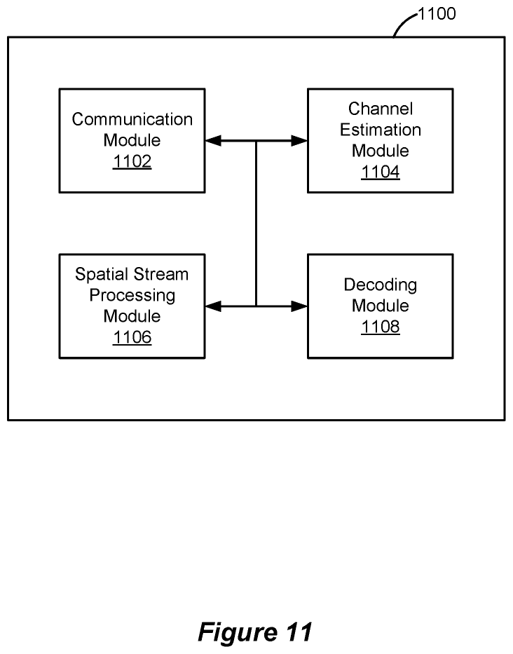

FIG. 11 shows a block diagram of an example wireless communication device 1100 for use in wireless communication according to some implementations. In some implementations, the wireless communication device 1100 is configured to decode a beamformed transmission received from a second wireless communication device. For example, the wireless communication device 1100 may be configured as a beamformee and the second wireless communication device may be configured as a beamformer. In some implementations, the wireless communication device 1100 is configured to perform the processes 700 or 800 described above with reference to FIGS. 7 and 8. In some implementations, the wireless communication device 1100 is further configured to perform the processes 500 or 600 described above with reference to FIGS. 5 and 6, respectively. In some implementations, the wireless communication device 1100 can be an example implementation of the wireless communication device 300 described above with reference to FIG. 3. In some implementations, the wireless communication device 1100 can be configured to operate within an AP, such as one of the APs 102 and 402 described above with reference to FIGS. 1 and 4A, respectively. In some other such implementations, the wireless communication device 1100 can be configured to operate within a STA, such as one of the STAs 104 and 404 described above with reference to FIGS. 1 and 4B, respectively. For example, in some scenarios, the wireless communication device 1100 may be operating as, or within, a first AP and the second wireless communication device may be operating as, or within, a different second AP. For example, the first AP may serve as a backhaul to, or a repeater for, the second AP. In some other scenarios, the wireless communication device 1100 may be operating as, or within, a STA and the second wireless communication device may be operating as, or within, an associated AP. For example, the wireless communication device 1100 can be a chip, SoC, chipset, package or device that includes at least one processor and at least one modem (for example, a Wi-Fi (IEEE 802.11) modem or a cellular modem). In other instances, the wireless communication device 1100 can be a STA or an AP that includes such a chip, SoC, chipset, package or device, as well as at least one transmitter, at least one receiver, and at least one antenna.

The wireless communication device 1100 includes a communication module 1102, a channel estimation module 1104, a spatial stream processing module 1106, and a decoding module 1108. Portions of one or more of the modules 1102, 1104, 1106 and 1108 may be implemented at least in part in hardware or firmware. For example, the communication, channel estimation and spatial stream processing modules 1102, 1104 and 1106, respectively, may be implemented at least in part by one or more modems (such as the modem 302). In some implementations, at least some of the modules 1102, 1104, 1106 and 1108 are implemented at least in part as software stored in a memory (such as the memory 308). For example, portions of one or more of the modules 1102, 1104, 1106 and 1108 can be implemented as non-transitory instructions (or “code”) executable by at least one processor (such as the processor 306) to perform the functions or operations of the respective module. The wireless communication device 1100 may also include the modules described above with reference to the wireless communication device 1000. Likewise, the wireless communication device 1000 may also include the modules described below with reference to the wireless communication device 1100.

The communication module 1102 includes a reception sub-module configured to receive wireless packets obtained by multiple coupled antennas and a radio over a wireless medium. For example, the communication module 1102 may be configured to receive SU and MU beamformed transmissions from a second wireless communication device. The channel estimation module 1104 is configured to generate a channel estimate matrix H based on a transmission received by the communication module 1102. The channel estimation module 1104 is further configured to partition the channel estimate matrix H into a first channel estimate matrix H₁ and a second channel estimate matrix H₂. For example, the channel estimation module 1104 may partition the channel estimate matrix into a first set of N_{SS1} rows and a second set of N_{SS2} rows, where the first set of N_{SS1} rows defines the first channel estimate matrix H₁, where the second set of N_{SS2} rows defines the second channel estimate matrix H₂, and where N_{SS1}+N_{SS2}=N_{SS}.

The spatial stream processing module 1106 is configured to partition the spatial streams into a first set of N_{SS1} spatial streams and a second set of N_{SS2} spatial streams. The design of the steering matrix used to precode the spatial streams enables the subsequent decoding of the first set of N_{SS1} spatial streams to be decoupled from the decoding of the second set of N_{SS2} spatial streams. The decoding module 1108 is configured to decode the partitioned spatial streams. For example, the decoding module 1108 may perform a first ML equalization operation on the first set of N_{SS1} spatial streams based on the first channel estimate matrix H₁ (obtained by the channel estimation module 1104) and the first feedback matrix Z₁ (obtained by the feedback module 1008) to generate a first sequence of complex numbers. Similarly, the decoding module 1108 may perform a second ML equalization operation on the second set of N_{SS2} spatial streams based on the second channel estimate matrix H₂ (obtained by the channel estimation module 1104) and the second feedback matrix Z₂ (obtained by the feedback module 1008) to generate a second sequence of complex numbers.

The decoding module 1108 may further be configured to determine a first set of LLR values based on the first sequence of complex numbers, for example, on a per bit position, per subcarrier, per stream basis. Similarly, the decoding module 1108 may be further configured to determine a second set of LLR values based on the second sequence of complex numbers on a per bit position, per subcarrier, per stream basis. The decoding module 1108 may then decode information bits for the first set of N_{SS1} spatial streams based on the first set of LLR values, and decode information bits for the second set of N_{SS2} spatial streams based on the second set of LLR values. In some implementations, the decoding module 1108 is further configured to spatially demultiplex (combine) the decoded information bits from all N_{SS} spatial streams, descramble the combined bits, and provide the descrambled bits to a MAC layer for further processing, evaluation or interpretation.

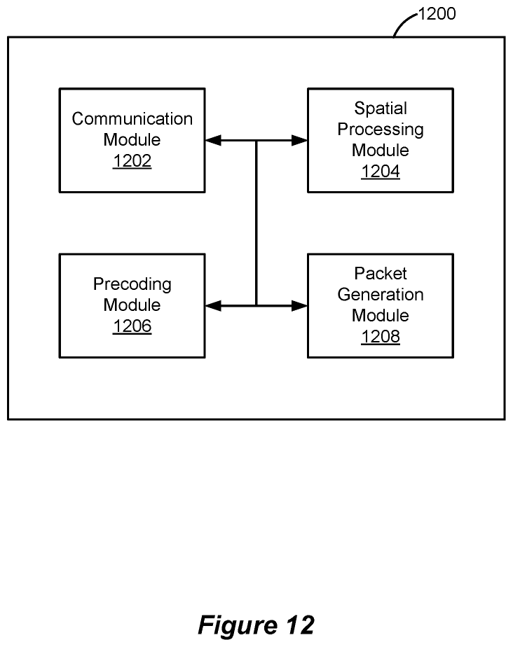

FIG. 12 shows a block diagram of an example wireless communication device 1200 for use in wireless communication according to some implementations. In some implementations, the wireless communication device 1200 is configured to generate a beamformed transmission for a second wireless communication device. For example, the wireless communication device 1200 may be configured as a beamformer and the second wireless communication device may be configured as a beamformee. In some implementations, the wireless communication device 1200 is configured to perform the process 900 described above with reference to FIG. 9. In some implementations, the wireless communication device 1200 can be an example implementation of the wireless communication device 300 described above with reference to FIG. 3. In some such implementations, the wireless communication device 1200 can be a device for use in an AP, such as one of the APs 102 and 402 described above with reference to FIGS. 1 and 4, respectively. For example, the wireless communication device 1200 can be a chip, SoC, chipset, package or device that includes at least one processor and at least one modem (for example, a Wi-Fi (IEEE 802.11) modem or a cellular modem). In other instances, the wireless communication device 1200 can be an AP that includes such a chip, SoC, chipset, package or device, as well as at least one transmitter, at least one receiver, and at least one antenna.

The wireless communication device 1200 includes a communication module 1202, a spatial processing module 1204, a precoding module 1206 and a packet generation module 1208. Portions of one or more of the modules 1202, 1204 and 1206 may be implemented at least in part in hardware or firmware. For example, portions of one or more of the modules 1202, 1204 and 1206 may be implemented at least in part by one or more modems (such as the modem 302). In some implementations, at least some of the modules 1202, 1204, 1206 and 1208 are implemented at least in part as software stored in a memory (such as the memory 308). For example, portions of one or more of the modules 1202, 1204, 1206 and 1208 can be implemented as non-transitory instructions (or “code”) executable by at least one processor (such as the processor 306) to perform the functions or operations of the respective module.

The communication module 1202 includes a transmission sub-module configured to output wireless packets for transmission by a coupled radio and multiple antennas over the wireless medium. For example, the communication module 1102 can output sounding signals for transmission to the second wireless communication device via N_{Tx} coupled antennas. In some implementations, each sounding signal is generated and transmitted as an NDP. Each sounding signal generally includes multiple LTFs where the number of LTFs is based on N_{Tx}.

The communication module 1202 is further configured to output precoded streams received from the precoding module 1206 for transmission to the second wireless communication device. For example, the communication module 1202 is configured to output both a first and a second set of precoded streams for transmission to the second wireless communication device. To output the first and the second sets of precoded streams, the communication module 1202 may be configured to first multiplex the first and the second sets of precoded streams to generate a multiplexed stream, transform the modulated symbols in the multiplexed stream via an IFFT, and apply various digital signal processing, digital-to-analog conversion, and frequency upconversion. The communication module 1202 may then provide the resultant analog signals to a radio, which may then amplify, otherwise process, and output the analog signals for transmission to the second wireless communication device via, for example, N_{Tx} coupled antennas.

The communication module 1202 also includes a reception sub-module configured to receive wireless packets obtained by multiple coupled antennas and a radio over a wireless medium. For example, the communication module 1202 may be configured to receive channel feedback information based on a transmitted sounding signal. In some implementations, the channel feedback information includes compressed feedback in the form of, for example, quantized angles obtained through a Givens rotation operation. In some implementations, the channel feedback information is received in a feedback packet that includes an HE Compressed Beamforming/CQI frame, which includes a CBF report field that includes the quantized angles. In some implementations, the HE Compressed Beamforming/CQI frame further comprises an average SNR for each spatial stream In some implementations, the channel feedback information additionally includes at least one of an indication of the number N_{SS1} of spatial streams to be used to generate the first set of precoded streams or an indication of the number N_{SS2} of spatial streams to be used to generate the second set of precoded streams, for example, so that the spatial processing module 1204 is aware of how the second wireless communication device partitioned the channel estimate to obtain the compressed feedback. In some such implementations, the indication of N_{SS1} or N_{SS2} may be included within a MIMO control field of the feedback packet. For example, the MIMO control field can include one of multiple possible bit sequences selected by the second wireless communication device as described above with reference to Tables (1) and (2).

The packet generation module 1208 is configured generate PPDUs including data to be transmitted to other wireless communication devices including the second wireless communication device. For example, the packet generation module 1208 may generate an A-MPDU that includes data for the second wireless communication device, and encapsulate the A-MPDU in a PPDU for transmission to the second wireless communication device. The spatial processing module 1204 is configured to partition PPDUs generated by the packet generation module into a number N_{SS} of spatial streams. For example, the spatial processing module 1204 may partition the PPDU for the second wireless communication device into a first set of N_{SS1} spatial streams and a second set of N_{SS2}, spatial streams.

The precoding module 1206 is configured to determine a first precoding matrix Z₁ for the first set of N_{SS1} spatial streams and a second precoding matrix Z₂ for the second set of N_{SS2}, spatial streams based on the channel feedback information. For example, the precoding module 1206 may be configured to decompress the compressed feedback received by the communication module 1202 to generate a steering matrix Z. The precoding module 1206 may then partition the steering matrix Z to determine first and second precoding matrices Z₁ and Z₂, respectively. The design of the steering matrix Z enables the first wireless communication device to precode the first and the second sets of spatial streams separately such that the decoding of the first set of N_{SS1} spatial streams may be decoupled from the decoding of the second set of N_{SS2} spatial streams at the second wireless communication device. The precoding module 1206 applies the first precoding matrix Z₁ to the first set of N_{SS1} spatial streams to precode the associated symbols to generate a first set of precoded streams. Similarly, the precoding module 1206 applies the second precoding matrix Z₂ to the second set of N_{SS2}, spatial streams to precode the associated symbols to generate a second set of precoded streams.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication by a first wireless communication device comprising:
receiving, from a second wireless communication device, a sounding signal;
generating a channel estimate matrix H based on the sounding signal;
partitioning the channel estimate matrix H into a first channel estimate matrix H₁ and a second channel estimate matrix H₂;
determining a first projection matrix P₁ based on the second channel estimate matrix H₂, and determining a second projection matrix P₂ based on the first channel estimate matrix H₁;
determining a first effective channel estimate matrix H_{Eff1} based on the first channel estimate matrix H₁ and the first projection matrix P₁, and determining a second effective channel estimate matrix H_{Eff2} based on the second channel estimate matrix H₂ and the second projection matrix P₂;
determining a combined feedback matrix Z based on the first effective channel estimate matrix H_{Eff1} and the second effective channel estimate matrix H_{Eff2}; and
outputting channel feedback information based on the combined feedback matrix Z for transmission to the second wireless communication device.

2. The method of claim 1, wherein the determination of the first projection matrix P₁ comprises determining the first projection matrix P₁ from the null space of the second channel estimate matrix H₂, and wherein the determination of the second projection matrix P₂ comprises determining the second projection matrix P₂ from the null space of the first channel estimate matrix H₁.

3. The method of claim 1, wherein the determination of the combined feedback matrix Z based on the first effective channel estimate matrix H_{Eff1} and the second effective channel estimate matrix H_{Eff2} comprises determining a first intermediate matrix V₁ based on the first effective channel estimate matrix H_{Eff1}, and determining a second intermediate matrix V₂ based on the second effective channel estimate matrix H_{Eff2}, wherein the determination of the combined feedback matrix Z is based on the first intermediate matrix V₁ and the second intermediate matrix V₂.

4. The method of claim 3, wherein:
the determination of the first intermediate matrix V₁ based on the first effective channel estimate matrix H_{Eff1} comprises performing a first factorization operation on the first effective channel estimate matrix H_{Eff1}; and
the determination of the second intermediate matrix V₂ based on the second effective channel estimate matrix H_{Eff2} comprises performing a second factorization operation on the second effective channel estimate matrix H_{Eff2}.

5. The method of claim 4, wherein:
the performance of the first factorization operation on the first effective channel estimate matrix H_{Eff1} comprises performing a first singular value decomposition (SVD) operation on the first effective channel estimate matrix H_{Eff1}; and
the performance of the second factorization operation on the second effective channel estimate matrix H_{Eff2} comprises performing a second SVD operation on the second effective channel estimate matrix H_{Eff2}.

6. The method of claim 3, wherein the determination of the combined feedback matrix Z comprises:
determining a first feedback matrix Z₁ based on the first intermediate matrix V₁ and the first projection matrix P₁;
determining a second feedback matrix Z₂ based on the second intermediate matrix V₂ and the second projection matrix P₂; and
determining the combined feedback matrix Z based on the first feedback matrix Z₁ and the second feedback matrix Z₂.

7. The method of claim 6, wherein the combined feedback matrix Z is an orthonormal block-diagonal matrix, and wherein the determination of the orthonormal block-diagonal steering matrix Z comprises stacking the first feedback matrix Z₁ and the second feedback matrix Z₂ such that the first and the second precoding matrices do not share any rows or columns in the combined feedback matrix Z.

8. The method of claim 6, wherein:
the first wireless communication device comprises or is coupled with N_{Rx} antennas configured to receive packets;
the second wireless communication device comprises or is coupled with N_{Tx} antennas configured to transmit packets.
the channel estimate matrix H comprises an N_{Rx}×N_{Tx} matrix;
the first channel estimate matrix H₁ consists of N_{SS1} rows and N_{Tx} columns of the channel estimate matrix H;
the second channel estimate matrix H₂ consists of N_{SS2}, rows and N_{Tx} columns of the channel estimate matrix H, wherein the N_{SS1} rows are different than the N_{SS2}, rows.

9. The method of claim 8, wherein the channel feedback information includes at least one of an indication of N_{SS1} or an indication of N_{SS2}.

10. The method of claim 8, further comprising:
receiving at least one beamformed transmission based on the channel feedback information, wherein the at least one beamformed transmission comprises at least one packet received via a number N_{SS} of spatial streams; and
partitioning the spatial streams into a first set of N_{SS1} spatial streams and a second set of N_{SS2} spatial streams, wherein N_{SS1}+N_{SS2}=N_{SS}.

11. The method of claim 10, further comprising:
generating a channel estimate matrix H_{B} based on the beamformed transmission;
partitioning the channel estimate matrix into a first channel estimate matrix H_{B1} and a second channel estimate matrix H_{B2};
decoding the first set of N_{SS1} spatial streams based on the first channel estimate matrix H_{B1} and the first feedback matrix Z₁; and
decoding the second set of N_{SS2}, spatial streams based on the second channel estimate matrix H_{B2} and the second feedback matrix Z₂.

12. The method of claim 11, wherein:
the decoding of the first set of N_{SS1} spatial streams based on the first channel estimate matrix H_{B1} and the first feedback matrix Z₁ comprises:
performing a first maximum likelihood (ML) equalization operation on the first set of N_{SS1} spatial streams based on the first channel estimate matrix H_{B1} and the first feedback matrix Z₁ to generate a first sequence of complex numbers,
determining a first set of logarithm likelihood ratio (LLR) values based on the first sequence of complex numbers on a per bit position, per subcarrier, per spatial stream basis, and
decoding information bits for the first set of N_{SS1} spatial streams based on the first set of LLR values; and
the decoding of the second set of N_{SS2} spatial streams based on the second channel estimate matrix H_{B2} and the second feedback matrix Z₂ comprises:
performing a second ML equalization operation on the second set of N_{SS2} spatial streams based on the second channel estimate matrix H_{B2} and the second feedback matrix Z₂ to generate a second sequence of complex numbers,
determining a second set of LLR values based on the second sequence of complex numbers on a per bit position, per subcarrier, per spatial stream basis, and
decoding information bits for the second set of N_{SS2}, spatial streams based on the second set of LLR values.

13. A mobile station comprising:
the wireless communication device of claim 1;
one or more transceivers coupled to the wireless communication device;
one or more antennas coupled to the one or more transceivers; and
a housing that encompasses the wireless communication device, the one or more transceivers and at least a portion of the one or more antennas.

14. A method for wireless communication by a first wireless communication device comprising:
outputting, for transmission to a second wireless communication device, a sounding signal;
receiving channel feedback information from the second wireless device based on the sounding signal;
determining a first precoding matrix Z₁ and a second precoding matrix Z₂ based on the channel feedback information;
generating at least one physical layer convergence protocol (PLCP) protocol data unit (PPDU) including data for the second wireless communication device;
partitioning the at least one PPDU into a first set of N_{SS1} spatial streams and a second set of N_{SS2}, spatial streams;
applying the first precoding matrix Z₁ to the first set of N_{SS1} spatial streams to generate a first set of precoded streams, and applying the second precoding matrix Z₂ to the second set of N_{SS2}, spatial streams to generate a second set of precoded streams; and
outputting the first and the second sets of precoded streams for transmission to the second wireless communication device.

15. The method of claim 14, wherein the determinations of the first precoding matrix Z₁ and the second precoding matrix Z₂ comprise generating a steering matrix Z based on the channel feedback information, wherein the determinations of the first precoding matrix Z₁ and the second precoding matrix Z₂ are based on the elements of the steering matrix.

16. The method of claim 14, wherein the channel feedback information includes at least one of an indication of N_{SS1} or an indication of N_{SS2}.

17. A wireless communication device comprising:
at least one modem;
at least one processor; and
at least one memory communicatively coupled with the at least one processor and storing processor-readable code that, when executed by the at least one processor, causes the wireless communication device to:
receive, from a second wireless communication device, a sounding signal;
generate a channel estimate matrix H based on the sounding signal;
partition the channel estimate matrix H into a first channel estimate matrix H₁ and a second channel estimate matrix H₂;
determine a first projection matrix P₁ based on the second channel estimate matrix H₂, and determine a second projection matrix P₂ based on the first channel estimate matrix H₁;
determine a first effective channel estimate matrix H_{Eff1} based on the first channel estimate matrix H₁ and the first projection matrix P₁, and determine a second effective channel estimate matrix H_{Eff2} based on the second channel estimate matrix H₂ and the second projection matrix P₂;
determine a combined feedback matrix Z based on the first effective channel estimate matrix H_{Eff1} and the second effective channel estimate matrix H_{Eff2}; and
output channel feedback information based on the combined feedback matrix Z for transmission to the second wireless communication device.

18. The wireless communication device of claim 17, wherein the determination of the first projection matrix P₁ comprises determining the first projection matrix P₁ from the null space of the second channel estimate matrix H₂, and wherein the determination of the second projection matrix P₂ comprises determining the second projection matrix P₂ from the null space of the first channel estimate matrix H₁.

19. The wireless communication device of claim 16, wherein the determination of the combined feedback matrix Z based on the first effective channel estimate matrix H_{Eff1} and the second effective channel estimate matrix H_{Eff2} comprises determining a first intermediate matrix V₁ based on the first effective channel estimate matrix H_{Eff1}, and determining a second intermediate matrix V₂ based on the second effective channel estimate matrix H_{Eff2}, wherein the determination of the combined feedback matrix Z is based on the first intermediate matrix V₁ and the second intermediate matrix V₂.

20. The wireless communication device of claim 19, wherein:
the determination of the first intermediate matrix V₁ based on the first effective channel estimate matrix H_{Eff1} comprises performing a first factorization operation on the first effective channel estimate matrix H_{Eff1}; and
the determination of the second intermediate matrix V₂ based on the second effective channel estimate matrix H_{Eff2} comprises performing a second factorization operation on the second effective channel estimate matrix H_{Eff2}.

21. The wireless communication device of claim 20, wherein:
the performance of the first factorization operation on the first effective channel estimate matrix H_{Eff1} comprises performing a first singular value decomposition (SVD) operation on the first effective channel estimate matrix H_{Eff1}; and
the performance of the second factorization operation on the second effective channel estimate matrix H_{Eff2} comprises performing a second SVD operation on the second effective channel estimate matrix H_{Eff2}.

22. The wireless communication device of claim 19, wherein the determination of the combined feedback matrix Z comprises:
determining a first feedback matrix Z₁ based on the first intermediate matrix V₁ and the first projection matrix P₁;
determining a second feedback matrix Z₂ based on the second intermediate matrix V₂ and the second projection matrix P₂; and
determining the combined feedback matrix Z based on the first feedback matrix Z₁ and the second feedback matrix Z₂.

23. The wireless communication device of claim 22, wherein the combined feedback matrix Z is an orthonormal block-diagonal matrix, and wherein the determination of the orthonormal block-diagonal steering matrix Z comprises stacking the first feedback matrix Z₁ and the second feedback matrix Z₂ such that the first and the second precoding matrices do not share any rows or columns in the combined feedback matrix Z.

24. The wireless communication device of claim 22, wherein:
the wireless communication device comprises or is coupled with N_{Rx} antennas configured to receive packets;
the second wireless communication device comprises or is coupled with N_{Tx} antennas configured to transmit packets.
the channel estimate matrix H comprises an N_{Rx}×N_{Tx} matrix;
the first channel estimate matrix H₁ consists of N_{SS1} rows and N_{Tx} columns of the channel estimate matrix H;
the second channel estimate matrix H₂ consists of N_{SS2}, rows and N_{Tx} columns of the channel estimate matrix H, wherein the N_{SS1} rows are different than the N_{SS2}, rows.

25. The wireless communication device of claim 24, wherein the channel feedback information includes at least one of an indication of N_{SS1} or an indication of N_{SS2}.

26. The wireless communication device of claim 24, wherein the code is further configured to, when executed by the at least one processor, cause the wireless communication device to:
receive at least one beamformed transmission based on the channel feedback information, wherein the at least one beamformed transmission comprises at least one packet received via a number N_{SS} of spatial streams; and
partition the spatial streams into a first set of N_{SS1} spatial streams and a second set of N_{SS2}, spatial streams, wherein N_{SS1}+N_{SS2}=N_{SS}.

27. The wireless communication device of claim 26, wherein the code is further configured to, when executed by the at least one processor, cause the wireless communication to:
generate a channel estimate matrix H_{B} based on the beamformed transmission;
partition the channel estimate matrix into a first channel estimate matrix H_{B1} and a second channel estimate matrix H_{B2};
decode the first set of N_{SS1} spatial streams based on the first channel estimate matrix H_{B1} and the first feedback matrix Z₁; and
decode the second set of N_{SS2}, spatial streams based on the second channel estimate matrix H_{B2} and the second feedback matrix Z₂.

28. The wireless communication device of claim 27, wherein:
the decoding of the first set of N_{SS1} spatial streams based on the first channel estimate matrix H_{B1} and the first feedback matrix Z₁ comprises:
performing a first maximum likelihood (ML) equalization operation on the first set of N_{SS1} spatial streams based on the first channel estimate matrix H_{B1} and the first feedback matrix Z₁ to generate a first sequence of complex numbers,
determining a first set of logarithm likelihood ratio (LLR) values based on the first sequence of complex numbers on a per bit position, per subcarrier, per spatial stream basis, and
decoding information bits for the first set of N_{SS1} spatial streams based on the first set of LLR values; and
the decoding of the second set of N_{SS2} spatial streams based on the second channel estimate matrix H_{B2} and the second feedback matrix Z₂ comprises:
performing a second ML equalization operation on the second set of N_{SS2} spatial streams based on the second channel estimate matrix H_{B2} and the second feedback matrix Z₂ to generate a second sequence of complex numbers,
determining a second set of LLR values based on the second sequence of complex numbers on a per bit position, per subcarrier, per spatial stream basis, and
decoding information bits for the second set of N_{SS2}, spatial streams based on the second set of LLR values.

29. A wireless communication device comprising:
at least one modem;
at least one processor; and
at least one memory communicatively coupled with the at least one processor and storing processor-readable code that, when executed by the at least one processor, causes the wireless communication device to:
output, for transmission to a second wireless communication device, a sounding signal;
receive channel feedback information from the second wireless device based on the sounding signal;
determine a first precoding matrix Z₁ and a second precoding matrix Z₂ based on the channel feedback information;
generate at least one physical layer convergence protocol (PLCP) protocol data unit (PPDU) including data for the second wireless communication device;
partition the at least one PPDU into a first set of N_{SS1} spatial streams and a second set of N_{SS2}, spatial streams;
apply the first precoding matrix Z₁ to the first set of N_{SS1} spatial streams to generate a first set of precoded streams, and apply the second precoding matrix Z₂ to the second set of N_{SS2} spatial streams to generate a second set of precoded streams; and
output the first and the second sets of precoded streams for transmission to the second wireless communication device.

30. The wireless communication device of claim 29, wherein the determinations of the first precoding matrix Z₁ and the second precoding matrix Z₂ comprise generating a steering matrix Z based on the channel feedback information, wherein the determinations of the first precoding matrix Z₁ and the second precoding matrix Z₂ are based on the elements of the steering matrix.

31. The wireless communication device of claim 29, wherein the channel feedback information includes at least one of an indication of N_{SS1} or an indication of N_{SS2}.
